(19) United States
(12) Patent Application Publication
(10) Pub. No.: US 2008/0010159 A1
(43) Pub. Date: Jan. 10, 2008

(54) EV method and system for paying and qualifying audiences

(76) Inventor: Michael T. Rossides, Scottsdale, AZ (US)

Correspondence Address: Michael Rossides, 11167 E. Mirasol Circle, Scottsdale, AZ, 85255, US

(21) Appl. No.: 11/903,229

(22) Filed: Sep. 20, 2007

Related U.S. Application Data
(63) Continuation-in-part of application No. 10/845,255, filed on May 13, 2004.

(51) Int. Cl. G06Q 30/00

(52) U.S. Cl. 705/14

(57) ABSTRACT

An expected value system for paying and qualifying audiences (EVSPQ) is an online database system for paying EV payments to users for their attention, provided they meet specified conditions. Advertisers post EV payment offers that recipient users accept. In an EVSPQ for paying “realbuyers” (EVSPQ-RB) a qualifying condition of payment is that a user makes a purchase after being exposed to a specified message. The inventive method is a module to be added to an EVSPQ-RB to limit EV payments paid for attention by a prospect for a specified purchase (economic transaction). The method comprises the following steps executed by the EVSPQ-RB: (1) the system stores all acceptances of EV payment by a recipient, (2) after the recipient wins an EV payment bet and also submits a payoff claim stating that a specified, required purchase was made, the system finds all acceptances that match the purchase, (3) the system enables a system operator to search the recipient's acceptance history to find additional matches and to eliminate false matches, yielding a full match set, (4) the system applies a division formula to all the EV payments in the full match set, such that the payoff of the bet that the recipient has won is discounted by an amount determined by this division formula.

### CROSS-REFERENCES TO RELATED APPLICATIONS

This application is a continuation-in-part application of U.S. utility patent application Ser. No. 10/845,255 entitled Improvements for an EV Method and System for Paying and Qualifying Audiences, filed May 13, 2004.

This specification was preceded by, and claims the benefit of, the following patent applications and disclosures:

Provisional application 60/074,819 entitled Methods for Paying People to Visit Websites, filed Feb. 17, 1998.

Provisional application 60/079,072 entitled Database System for Mutual Search and Bet Advertising, filed Mar. 23, 1998.

Provisional application 60/085,011 entitled Database System for Mutual Search and Bet Advertising, filed May 11, 1998.

U.S. utility application Ser. No. 09/100,601 entitled Database System for Mutual Search and Bet Advertising, filed Jun. 18, 1998.

Disclosure document 451,365, filed Feb. 16, 1999.

Provisional application 60/142,592 entitled Methods and Systems for Paying and Qualifying Prospects, filed Jul. 7, 1999.

U.S. utility application Ser. No. 09/536,727 entitled Expected Value Methods and Systems for Paying and Qualifying, filed Mar. 28, 2000.

Disclosure document 477,084 entitled MOAE, Spiff Nation, Relevance Trick, filed Jul. 17, 2000.

Disclosure document 481,613 entitled Various, filed Oct. 23, 2000.

Disclosure document 531,657 entitled Expected Value Methods and Systems for Paying and Qualifying—Additional Matter, filed May 19, 2003.

U.S. utility application Ser. No. 10/042,975 entitled Expected Value Methods and Systems for Paying and Qualifying, filed Jan. 7, 2002, and incorporated by reference.

This application also incorporates by reference, U.S. utility application Ser. No. 10/700,836, Method and System for Paying Decision Makers for Attention, filed on Nov. 3, 2003.

This application includes the Description of U.S. utility application Ser. No. 10/811,643, Methods for Transferring Payment in EV Payment and Verification Systems, filed Mar. 29, 2004.

### STATEMENT REGARDING FEDERALLY SPONSORED RESEARCH

Not applicable.

### BACKGROUND

### Description of Related Art

This invention relates to methods for paying qualified audiences for their attention.

U.S. patent application Ser. No. 10/042,975, Expected Value Methods and Systems for Paying and Qualifying, and certain preceding applications cited above, also by the author, disclosed a system for paying users for their attention, and for qualifying (verifying) that those users met conditions set forth by paying advertisers. U.S. patent application Ser. No. 10/042,975 further disclosed a system for paying people—the application called them realbuyers—who bought a specified product or service at some point after being exposed to an advertising (sales) message.

This application discloses several improvement methods that enhance the invention of Ser. No. 10/042,975. The author is not aware of other disclosures of these improvement methods (further, the author does not know of any disclosure that describes any method or system equivalent to the disclosure in U.S. patent application Ser. No. 10/042,975).

This continuation-in-part application adds new matter concerning the logging of phone calls, in which callers report their calls. The specification also elaborates on methods previously disclosed for using guarantees to infer caller intent and for reducing the cost of inspections.

### BRIEF SUMMARY OF THE INVENTION

The object of the invention is to limit the payments collected by users of a directory system for paying people for their attention, especially people whose key qualification is that they buy a given product or engage in a given economic transaction after exposure to a message.

An expected value system for paying and qualifying audiences (EVSPQ) is an online database system for paying EV payments to users for their attention, provided they meet specified conditions. Advertisers post EV payment offers that recipient users accept.

In an EVSPQ for paying “realbuyers” (EVSPQ-RB) a qualifying condition of payment is that a user makes a purchase after being exposed to a specified message. The inventive method is a module to be added to an EVSPQ-RB to limit EV payments paid for attention by a prospect for a specified purchase (economic transaction).

The method comprises the following steps executed by the EVSPQ-RB: (1) the system stores all acceptances of EV payment by a recipient, (2) after the recipient wins an EV payment bet and also submits a payoff claim stating that a specified, required purchase was made, the system finds all acceptances that match the purchase, (3) the system enables a system operator to search the recipient's acceptance history to find additional matches and to eliminate false matches, yielding a full match set, (4) the system applies a division formula to all the EV payments in the full match set, such that the payoff of the bet that the recipient has won is discounted by an amount determined by this division formula.

### BRIEF DESCRIPTION OF THE DRAWINGS

FIG. 1 shows the output of a method for creating a payment-for-attention offer.

FIG. 2 shows the output of a method for creating a payment-for-attention offer.

FIG. 3 shows the output of a method for compiling payment offers in one output.

FIG. 4 shows a method for enforcing a limit on EV payments that apply to a purchase.

FIG. 5 shows a method for employing a switch to register a pay-the-caller call.

FIG. 6 shows a method for employing a browser-phone to register a pay-the-caller call.

FIG. 7 shows a method for employing a browser-phone to register a pay-the-caller call.

FIG. 8 shows a flowchart for a method of using a guarantee bond to differentiate callers.

FIG. 9 shows a method for register payment offer acceptances using caller reporting.

### DETAILED DESCRIPTION OF THE INVENTION

### Contents

How this Specification is Written

Definition of EVSPQ, the System to Be Improved (i.e., Where the Invention Applies)

Initial Definitions

Part 1: Methods for Improving a Pay-for-Placement EVSPQ

Part 2: Methods for Improving an EVSPQ-RB

Part 3: In an EVSPQ-RB, Limiting EV Payments that Apply to a Specified Purchase

Part 4: Embodiments for Registering Acceptances of Pay-the-Realbuyer-Caller Offers

Part 5: Methods for Transferring Payment

Copy of specification of U.S. patent application Ser. No. 10/811,643, Methods for Transferring Payment in EV Payment and Verification Systems
   Part 6: Methods for Reducing Inspection Costs
   How this Specification is Written

This specification is organized as descriptions of modules (processes) for operating a special-purpose, online computer database. The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing database entities that communicate with each other.

The goal of this specification is to disclose the novel aspects of the inventive methods. There is no ideal way to present these aspects, and so, those skilled in technical writing or programming will see better ways to organize and present this disclosure.

Example cases are provided. Those skilled in the art will know that these examples are illustrative only and do not limit the range of applications of the present invention.

Definition of EVSPQ, the Method System to be Improved

U.S. patent application Ser. No. 10/042,975, Expected Value Methods and Systems for Paying and Qualifying, also by the author, disclosed a system for paying users for their attention, and for qualifying (verifying) that those users met conditions set forth by paying advertisers.

U.S. patent application Ser. No. 10/042,975 further disclosed a system for paying people—the application called them realbuyers—who buy a specified product or service at some point after being exposed to a sales message.

We incorporate by reference all the methods taught in application Ser. No. 10/042,975, and related, referenced applications above.

This specification discloses several methods for improving and enhancing the operation of the system of application Ser. No. 10/042,975.

For clarity's sake, we summarize key aspects of the invention of Ser. No. 10/042,975, since the inventive methods disclosed here build upon that invention. However, we do not rely on these summaries, but upon the disclosure of application Ser. No. 10/042,975.

An expected value system for paying and qualifying (EVSPQ) is an online database system for paying users for their attention provided that they meet specified conditions. In this system, advertisers post EV payment offers.

Using the system, a recipient of EV payment accepts a payment offer; the system stores this acceptance in a recipient's acceptance history, and triggers the execution of an EV payment bet corresponding to the terms of the payment offer. If the recipient wins this payment bet, the EVSPQ enables the recipient to state whether he has met the conditions of the payment offer and, therefore, is owed the payment bet payoff.

In an EVSPQ for paying “realbuyers” (EVSPQ-RB) a qualifying condition of payment is that a user buys a specified product or service, or from a specified seller, after being exposed to a corresponding, specified, sales message.

Inventive Method Applies to Non-Competitive Directory Embodiment of an EVSPQ

One embodiment of an EVSPQ is a “non-competitive” directory in which different sellers post payment-for-attention offers to users. We say non-competitive in the sense that competing offers are not shown together. The purpose of the directory—also called a service bureau—is to enable sellers to transact these pay-for-attention offers. Sellers will often want to cooperate to make sure that recipients of payment are not gaming those offers.

Pay-for-Placement Embodiment of an EVSPQ

One embodiment of an EVSPQ is a “competitive” directory in which different sellers post payment-for-attention offers to prospective realbuyers, such that offers are presented competitively, under search criteria. One sub-embodiment of this kind of competitive directory is a pay-for-placement directory in which offers are ranked under a given set of search criteria according to how much the sellers offer to pay realbuyers. Thus, for instance, two offers under the search criteria barbershop+zip code 85254, might offer pay a realbuyer EV$2 and EV$1, respectively, to call the advertisers. In this case, the offer for EV$2 would be presented above the EV$1 offer.

Initial Definitions

Note: The definitions below are meant to be consistent with those in application Ser. No. 10/042,975, although there are minor differences in terms.

EVSPQ and EVSPQ-RB—see above. Note: in this specification we usually refer to an EVSPQ and an EVSPQ-RB in the singular. Importantly, most of the methods discussed and disclosed can apply to a group of EVSPQ's and EVSPQ-RB's that pool data (especially acceptance history data, defined below). In fact, a group of EVSPQ's and EVSPQ-RB's that pool data can be considered one system.

Two-Bet EV Payment Process. An EV payment bet process, also called a parlay process, in which the payoff from a first bet is the expected value of the second bet, for a recipient of payment. For more detail, see U.S. patent application Ser. No. 10/811,643, referenced above.

Seller. A person or organization (or agent) that makes an EV payment-for-attention offer in an EVSPQ or EVSPQ-RB. Seller is a broad, economics term encompassing any person/org selling/leasing/loaning a product or service of any kind, or soliciting money or commodities.

Advertiser. In this specification, advertiser means the same thing as seller.

Sales Message. Any kind of message, delivered in any way, including interactive messaging, including conversation advertising with a prospect.

Advertisement (Ad). Advertisement will mean the same thing as a sales message.

Recipient. A user who has accepted an EV payment-for-attention offer. The user has thus received a form of provisional payment. For brevity's sake, often referred to as Reece.

Acceptance. An action by a recipient to accept a payment-for-attention offer made by a seller. Another term for an acceptance is a claim.

Acceptance Record. The record that the EVSPQ stores for all the information involved in an acceptance from the point of acceptance through possible payment of a payoff. Another term for acceptance record is claim record.

Payoff Claim. In order for a user to collect the payoff from an EV payment bet, he must submit a claim that he has met the conditions of the payment offer. A payoff claim can include evidence that he has met the conditions of the payment offer.

Recipient's Acceptance History. A compilation file kept by the EVSPQ of all of a recipient's acceptance records. Two other terms for acceptance history are a claim history and a user history. An acceptance history will include records of payoff claims made by a recipient. Or, an acceptance history and a payoff claim history will be separate files within a larger user history. (Various storage schemes are possible for acceptance and payoff claim information, as is well known to those skilled in the art.)

Sale (also called a Purchase). Any kind of sale or purchase (any expenditure of money for some product). Sale is a broad, economics term encompassing one-time purchases, leases, loans, donations, and so forth—virtually any kind of economic transaction.

Buyer. A broad, economics term that encompasses any person or entity (org) that buys/rents/borrow/donates—i.e., that is on one end of an economic transaction.

Realbuyer (RB). A recipient who buys a product in accordance with a realbuyer payment offer, as defined in application Ser. No. 10/042,975, and related applications by the author.

Prospect. A person or organization that might become a buyer.

Product. A broad, economics term encompassing any product or service (even donations).

### Part 1

### Methods for Improving a Pay-for-Placement EVSPQ

Contents of Part 1

1A. Context: Methods Apply to a Pay-for-Placement EVSPQ
1B. Methods of Registering Acceptances of EV Payment
1C. Method for Improving the Relevance of Pay-Per-Action Offers in a Pay-for-Placement Directory
1D. Method for Compiling Pay-for-Attention Offers
1E. Digression: Why Pay-Per-Impression Headlines?
1F. Digression: Employing High Value, Message Categories
1G. Digression: The Implications of a “Customer Of” Category in an EVSPQ
   1A. Context: Methods Apply to a Pay-for-Placement EVSPQ

The methods disclosed in Part 1 apply to the operation of an EVSPQ directory, especially a pay-for-placement embodiment.

In an EVSPQ pay-for-placement directory, a set of payment offers is presented as search results that are found to match search criteria, entered by a recipient.

In a preferred embodiment, the search criteria can define some or all of the conditions of being eligible to receive payment. That is (as disclosed in application Ser. Nos. 09/536,727 and 10/042,975), the search criteria have, at least, three roles in an EVSPQ:
1. they enable an advertiser to describe an offer
2. they enable recipients find the offer
3. they act as conditions of payment.

So, search criteria are also qualifying conditions (qualifications) of the offers that match the criteria. In other words, the recipient himself must match the search criteria, in effect.

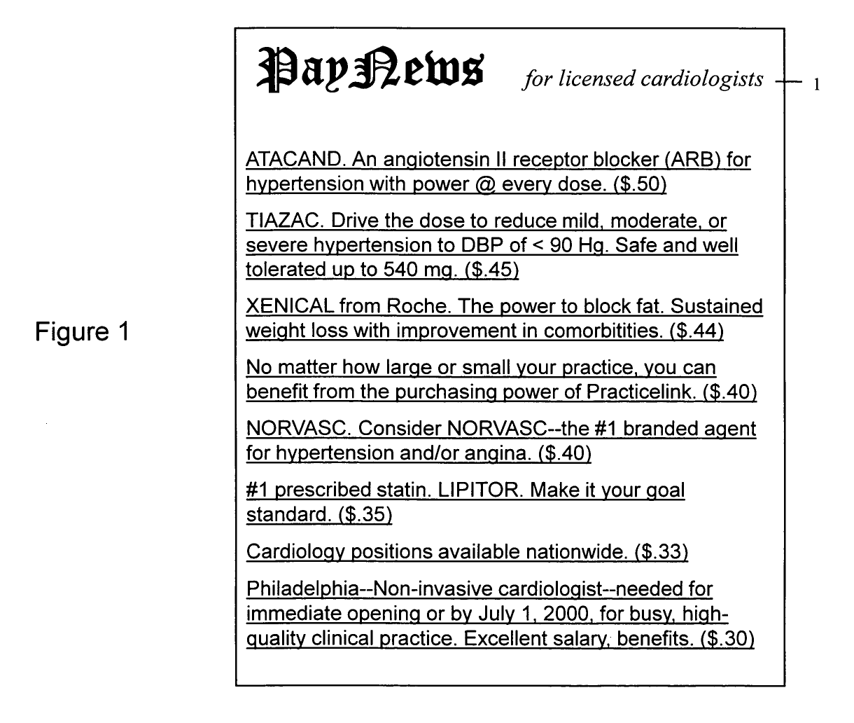

For example, as shown in FIG. 1, an advertiser could enter an offer to pay licensed cardiologists (1) for their attention to an ad. A recipient could find this offer, and other matching offers, by entering the search criteria licensed cardiologist. All the offers presented under licensed cardiologist would require that a recipient be a licensed cardiologist in order to be paid the EV amounts shown. Thus, the search criteria are also qualifying conditions.

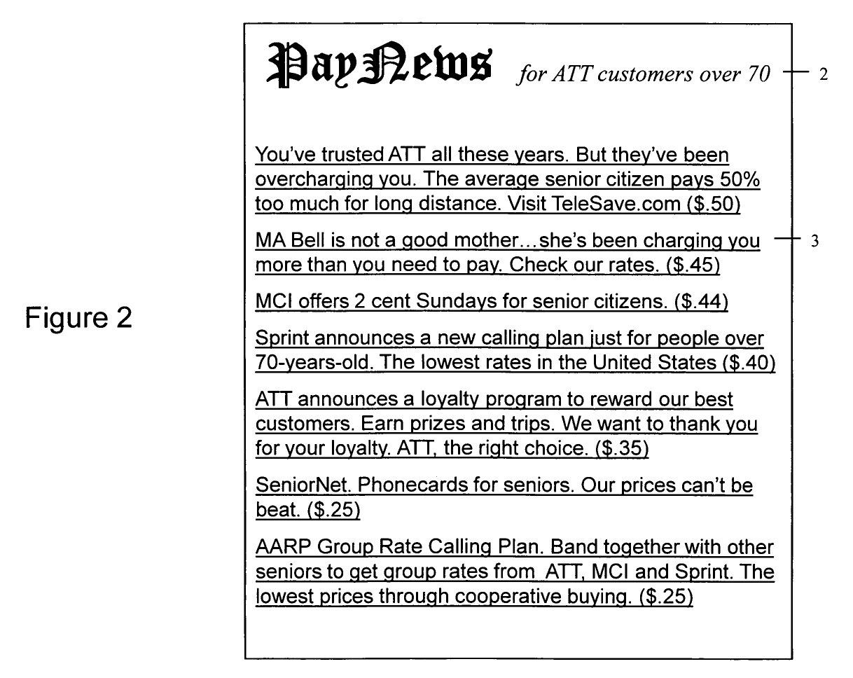

As another example, as shown in FIG. 2, an advertiser could enter and offer to pay customers of ATT over 70 year-old (2) for their attention to an ad. A recipient could find this offer, and other matching offers, by entering ATT customer and over 70-years old. To be eligible for payment, the recipient himself would have to match those criteria/qualifications.

1B. Methods of Registering Acceptances of EV Payment

As disclosed in application Ser. Nos. 09/536,727 and 10/042,975, there are different ways that an EVSPQ can enable an offer to be accepted. Most basically, there are two ways: getting paid for an action and getting paid for an impression.

By paid-per-action we mean that the recipient must do something—such as click on a link, press a button, make a phone call, issue a voice command—signifying that he is accepting the offer (which we can also think of as registering an EV payment claim).

By paid-per-impression we mean that a recipient enters search terms into the EVSPQ and is presented directly with an ad or ads, and gets paid automatically for viewing those ad(s).

As shown in FIG. 2, an ad could be as simple as a link headline (3). The recipient would accept the ad payment offer simply by being exposed to this link.

It is also possible for the EVSPQ to include links that incorporate both methods of acceptance—that is, a recipient would be paid for being exposed to a link headline, and be paid a second time by clicking on the link (or taking some equivalent action).

1C. Method for Improving the Relevance of Pay-Per-Action Offers in a Pay-for-Placement Directory

Current pay-for-placement directories are usually “pay-per-click” where an advertiser pays the medium when a search clicks on a link.

An EVSPQ pay-for-placement directory is different, in that payment goes (all or part) to the searcher who clicks on a link, provided the searcher matches the qualifying conditions represented by the link.

But, in any pure pay-per-click, pay-for-placement directory, a relevance problem occurs because advertisers can game the system. An advertiser can make a high bid under a given search criteria, placing an ad at the top of a list of ads even though the ad is not highly relevant to the search criteria, for most searchers.

For example, under the search term books, an advertiser could bid the highest for an ad link entitled christianbooks.com. The high bid could put the ad at the top of all the ads under the term books even though only a small fraction of searchers are interested in Christian books.

An advertiser can place an irrelevant ad listing this way because he suffers little penalty. While the advertiser pays when a searcher clicks on the link, only searchers interested in Christian books will select the link, so the advertiser gets no penalty for inconveniencing all those searchers not interested in Christian books.

(An EVSPQ directory can inherently have a penalty for irrelevant listings because a searcher could click on the irrelevant listing and still get paid based upon matching the search criteria, for instance a searcher entering books could get paid for the christianbooks.com link if he buys some kind of book.)

Conventional pay-per-click directories guard against irrelevancy by requiring a certain click-through rate, and by using human editors to enforce relevancy.

Editors are costly.

Here we disclose a better, market based solution: use hybrid links that pay-per-impression and pay-per-click.

That way, an advertiser has to pay each time a qualified recipient views the advertiser's link.

For example, let us assume that the EVSPQ is a pay-for-placement EVSPQ-RB that employs double-pay links. Assuming this embodiment, if christianbooks.com lists itself under books, then each time a searcher looks up books, he will see christianbooks.com and he will get paid for that view, if he turns out to be a real book buyer. Christianbooks.com will, therefore, be penalized for exposing their ad to book buyers in general, even though the buyers might not click on the link.

Editors are not needed then to police relevancy.

To make double-pay links far easier for advertisers to enter and manage, the EVSPQ can include a formula such that the pay-per-impression amount is a fraction of the pay-per-click amount, which means that an advertiser only has to enter one bid for a link. For instance, if the formula is that a payment-per-click is 10 times a payment per-impression, then if a payment per impression is 5 EV cents, the pay-per-click would be 50 EV cents.

An alternative method is to charge the advertiser a pay-per-impression fee that goes to the medium, and not to searchers. Searchers would be paid for an action, such as clicking on a link. Such a pay-per-impression fee will still penalize irrelevant listings.

1D. Method for Compiling Pay-for-Attention Offers

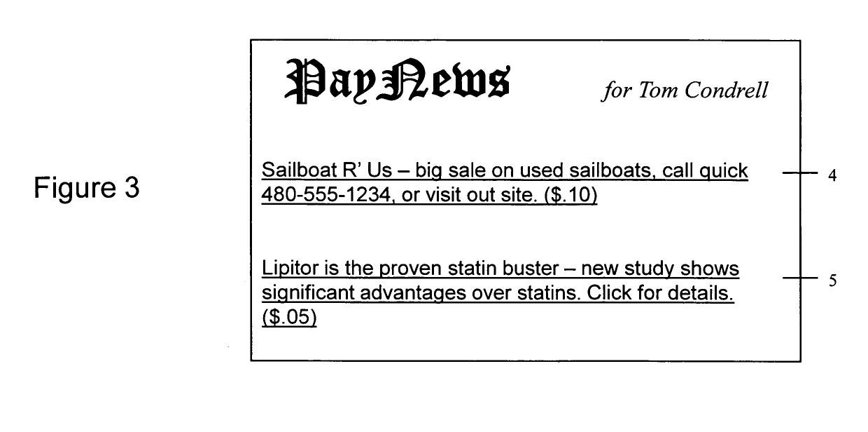

An EVSPQ directory can include steps for enabling a user to sign-up to receive payment offers that match different sets of search criteria. The directory can further include steps for compiling these offers, and sorting them according to payment amounts. For example, as shown in FIG. 3, a recipient could receive, say, offers for owners of sailboats (4) and for licensed cardiologists (5), such that the offers are compiled in a single list that is sorted according to payment.

Accordingly, the invention can provide a method for enabling a user to specify different sets of search criteria, to receive offers that match these different sets of criteria in a single list and, to sort this list according to the amount that the offers pay the recipients for attention.

A modification of this method is to enable a user to increase the sort position of offers that match a set of criteria by specifying that all the offers matching that set should be increased in value by a factor specified by the recipient. That way, the recipient can modify an offer's position in a list of offers according to how much interest the recipient has in the offers.

For example, a user might prefer to receive offers for sailboat owners more than offers for licensed cardiologists. So, the user could specify that the payment amounts for all sailboat owner offers should be increased by a specified, virtual percentage, say, 60%. If an offer for sailboat owners was paying 10 EV cents, then, and an offer for licensed cardiologists was paying 12 EV cents, the sailboat owner offer would be effectively increased to 16 EV cents, placing the offer above the licensed cardiologist offer, in a compiled, sorted list of offers.

Accordingly, the invention provides a method, in an EVSPQ, for enabling a user to virtually increase the value of EV payments by a percentage, specified by the recipient, solely for the purpose of sorting offers, but not for the purpose of actual payment. The advertiser's bid amount would specify actual payment, which would still apply for the presented offers. The EVSPQ could show the actual payment amount and the virtually increased amount together.

1E. Digression: Why Pay-Per-Impression Headline Links?

An EVSPQ, pay-for-placement embodiment, using a pay-per-impression method will be a useful embodiment, for reasons discussed in the digression below.

For concreteness in this digression, we will call an EVSPQ that employs pay-per-impression links as Paynews.

Each ad in Paynews is unsolicited in the sense that the viewer/recipient is not searching for a product or service. He is looking for paid announcements, but not for a specified product, where he initiated a search.

That means the chances are low that the viewer will be interested in a given ad. With chances low, the advertisers can only pay a small amount of money.

And if the advertiser can only pay a small amount of money, then she can only take a small amount of the reader's time—roughly, the amount of time necessary to skim a headline. For example, if Reece gets paid 5 EV cents to read an ad and it takes Reece 2 seconds to read it, then Paul is being paid $90 EV per hour. If an ad takes much longer to read, say 30 seconds, then the rate drops dramatically, to $6 per hour.

If a reader is interested in a headline, he can click on the link to read more or call the advertiser on the phone, or receive some other additional ad message.

1F. Digression: Employing High Value, Message Categories

For efficient communication, it is critical to have high expected value messages from the point of view of senders (advertisers) and recipients. In this context, expected value, confusingly, means the value of the message itself, to the sender and recipient, not the payments transacted between sender and recipient.

There is a direct relationship between the expected value of a message and the payment that can be made, though. The payment is sort of a measure of the expected value of a message.

Certain message categories have a high expected value, on average, to sender and recipient.

We will list some of these categories, which an EVSPQ can enable senders and recipients to use to communicate with each other by providing an offer creation form for advertisers that enables the advertisers to specify offers in these categories, and by providing a search form that enables recipients to search by these categories.

We will state these categories as statements that a recipient might use colloquially. The categories indicate qualifications that make people valuable to reach for senders (advertisers). Where we leave a blank space below, an advertiser or searcher would fill in a description, of course, as in “my profession is cardiologist.” The categories below comprise a limited list, and can be modified and described with more detail, as is obvious to those skilled in the art:

My profession/job is .
I am a licensed .
My title is .
I am currently a customer of company.
I am the decision maker at my organization for buying .
I am the decision maker at my organization for loaning money to .
I am the decision maker at my organization for granting .
I own .
I am a member of .
I contribute to .
I am a registered voter.
My title is .
My position in the government is .
My organization is and my title is .

1G. Digression: The Implications of a “Customer Of” Category in an EVSPQ

We note, as shown above, that the EVSPQ can be used to reach customers of a specified company. This category is somewhat similar, but different from the use of a realbuyer condition in an EVSQP-RB application because in that application a user states that he intends to buy a specified product or that he intends to buy from a specified company. So, an EVSPQ-RB will, it seems be the more important application by far.

Still, the use of an I am a customer of ______ company category can have important implications because it opens a direct channel to any company's customers. Consequently:
1. A company's competitors can to communicate with its customers, which means customer lists are no longer private.
2. More radically, perhaps, a company's customers to can communicate with each other, which may lead to customers unionizing against individual businesses to negotiate better terms. If possible, businesses may have to change their contracts to prevent unionizing from destroying the businesses.

### Part 2

### Methods for Improving an EVSPQ-RB

Contents of Part 2

2A. What Is Disclosed in Part 2

2B. Encompassing Physically Mailed Ads

2C. Encompassing Donations/Grants

2D. Additions to an EVSPQ-RB to Better Accommodate Loan Products

2E. Methods for Enabling Counter-Offers to Realbuyer Payment Offers

2F. Enabling a Searcher to Enter Multiple Names in a Search

2G. Method for Enabling Jobseekers to Tailor Offers to Realbuyer Employers

2H. Method for Enabling Employers to Pay Job Seekers for their Attention

2A. What is Disclosed in Part 2

The inventive methods disclosed in Part 2 apply to an EVSPQ-RB. For concreteness sake, we will assume that the EVSPQ-RB is embodied as a “service bureau” directory in which payment offers from different sellers are presented under search criteria. Such a directory may be a pay-for-placement directory or a directory that presents offers using some other sorting rule(s).

For example, assume that Reece enters the search term, notebook computer, into the system, and the system returns three payment offers, each offering an EV payment to Reece for looking at a different web page ad for notebook computers.

Part 2 will note that an EVSPQ-RB can be used for paying realbuyers to receive physically mailed ads, although the author believes that this application is clearly covered by U.S. application Ser. No. 10/042,975.

Part 2 will describe a minor method that can be included in the EVSPQ-RB of application Ser. No. 10/042,975 for making it easier for the EVSPQ-RB to enable payments to realbuyers who are donors/grantors. The method and system of application Ser. No. 10/042,975 can indeed be used to pay donors, but we are simply adding a minor, improvement method, in case it is helpful for patenting purposes.

Part 2 will describe a minor method that can be included in the EVSPQ-RB of application Ser. No. 10/042,975 for making it easy for the EVSPQ-RB to enable payments to realbuyers of loan products (borrowers). The method and system of application Ser. No. 10/042,975 can indeed be used to pay realborrowers; we are simply adding a minor improvement method, in case it is helpful for patenting purposes.

Part 2 will disclose a minor method for enabling a realbuyer to make a counter-offer to a realbuyer payment offer.

Part 2 will disclose a method for enabling a searcher to enter multiple names in a search.

Part 2 will disclose a method for enabling employers to pay job seekers for attention.

2B. Encompassing Physically Mailed Ads

U.S. application Ser. No. 10/042,975 disclosed that the methods and systems called an EVSPQ, and EVSPQ-RB could be used to pay realbuyers for their attention to a sales message. The application did not specifically mention physically mailed ads, but in case it is not obvious, let us mention that the inventive method and system of that application can include steps for enabling a seller to enter an offer to pay realbuyers for their attention to a physically mailed ad, and for a recipient to accept such an offer, the acceptance triggering the physical sending of the corresponding ad to the recipient's address, stored in the recipient's user account.

2C. Encompassing Donations/Grants

U.S. application Ser. No. 10/042,975 disclosed that the methods and systems called an EVSPQ, and EVSPQ-RB could be used to pay realbuyers for their attention to a sales message.

Buyer is a very broad economics term that encompasses any a person or entity that buys any product or service. The author feels that this term applies also to donors, i.e., people or entities that give money or some other commodity.

However, as certain people might not feel that the term buyer encompasses donors, let us point out that the method and system U.S. application Ser. No. 10/042,975 can include steps for enabling a seller (solicitor)—a person or entity that might receive a donation—to enter an offer to pay a potential donor for the donor's attention to a sales message (a message to convince the donor to donate money to a given person, organization, or cause).

The conditions that define a real “donor” are directly analogous to those of a realbuyer, i.e., a real donor would be a person or entity that donated an amount of money for a specified purpose, or to a specified organization, within a specified period of time.

Thus, an EVSPQ-RB can include an offer creation form that enables a seller (advertiser/solicitor) to define a realdonor to be paid for attention, with a set of qualifying conditions that the donor must meet, including:
Name (or other descriptors) of the cause or purpose of the donation
Name of the organization that the prospective real donor intends to donate to
Amount of money or other commodity to be donated,
Location of the donation
The time period when the donation will take place.

For example, using such an offer creation form, a seller (solicitor) could craft a real donor offer to pay for the attention of user who is going to donate, within six months:
to diabetes research in general, or
to a particular diabetes research experiment, named and otherwise described, or
to the American Diabetes Association.

Likewise, an EVSPQ-RB can include a search form for enabling users to search for realdonor pay-for-attention offers according to criteria that describe a potential donation that the user intends to make, and that, possibly describe the donor as well (e.g., describe the qualifications of a donation decision maker).

Where a donor is a foundation or non-governmental organization or government organization, a decision maker or decision makers within the organization will decide where to donate/grant money. In this case, a real donor offer will include a definition of a decision maker (as disclosed in application Ser. No. 10/042,975). The EVSPQ-RB can include fields in an offer form for specifying the definition, or the definition can be a meta-rule of the system.

As disclosed in application Ser. No. 10/042,975, the inventive method can enable a seller (solicitor) to set the payment amount to vary with the conditions of the offer. For example, a real donor offer can offer to pay the donor a percentage of the amount of the donation that is made.

2D. Additions to an EVSPQ-RB to Better Accommodate Loan Products

The invention of U.S. application Ser. No. 10/042,975 covered products and services that are loans, in the sense that lenders are a type of seller, and borrowers are a type of buyer.

However, application Ser. No. 10/042,975 did not describe how the invention could enable sellers (lenders) to specify certain conditions that conditions for defining real borrower eligible for payment-for-attention.

Although the author feels that these conditions are directly analogous to those disclosed in application Ser. No. 10/042,975, we describe certain conditions here, in case they are useful for patenting purposes.

Accordingly, the invention of application Ser. No. 10/042,975 can enable a seller (lender or lender agent) to enter, as part of a real buyer payment offer, in a payment offer form, conditions of a realbuyer payment offer where a loan is the product being advertised, including the following conditions that a realbuyer (realborrower) must meet to be eligible for payment:
Name, (or other descriptor) of the loan
Size of the loan
Interest rate on the loan
Term of the loan.
Closing costs of the loan
Other loan fees
The time period by which time the loan is closed.

As with any product, loan products can be described/defined with high specificity.

As disclosed in application Ser. No. 10/042,975, the inventive method and system can enable a seller to vary the payment according to the conditions of the payment offer. For example, a seller could make the amount of payment-for-attention dependent on the size of the loan, or upon the interest rate, and/or upon the term of the loan.

As disclosed in application Ser. No. 10/042,975, a seller could stipulate a specific seller or sellers as part of a realbuyer payment offer. Thus, analogously, the inventive method can include in a payment offer form fields for enabling a seller to state that a realbuyer would only be paid if he borrowed money from a specified lender or lenders.

For example, an offer could state that Reece would only be paid if he borrowed a specified amount of money from Morgan Stanley or Goldman Sachs within a specified period of time.

2E. Methods for Enabling Counter-Offers to Realbuyer Payment Offers

The invention of application Ser. No. 10/042,975 enables sellers to offer payments to realbuyer prospects. The invention can also include means for enabling a prospect to find an offer, and make a counter-offer to the seller, such that the prospect asks for more payment.

Accordingly, the invention can provide a method for:
Enabling a recipient to find a realbuyer payment offer,
Enabling a recipient to send a message to the corresponding seller (offeror) in which the recipient states the amount of EV payment he want to receive for his attention to the message specified in the seller's payment offer,
Enabling the corresponding seller to receive the message,
Enabling the seller to respond in “yes” or “no,”
Enabling the recipient to receive the seller's response,
If the seller's response is “yes,” increasing the payment offer to the recipient by the amount that the recipient requested.
   2F. Enabling a Searcher to Enter Multiple Names in a Search

An effective way to use an EVSPQ-RB directory will be to enter highly specific names of products and/or sellers. For example, rather than enter dentist, Reece might enter Smiles by Design. As another example, rather than enter digital camera, Reece might enter Canon Powershot 500.

The advantage of entering highly specific search criteria is that a seller usually can offer a lot more EV payment to the recipient than if a recipient enters broad criteria.

The disadvantage is that a recipient is under the condition of buying the narrowly described product or service. For instance, if a recipient enters Smiles by Design, then he must buy from Smiles by Design in order to be eligible for a realbuyer payment (we ignore an important exception to this rule that may prevail, which is that a realbuyer might get paid if he buys from the seller who is paying for his attention).

Likewise, if a user enters Canon Powershot 500, then he (we will assume) must buy this specific camera in order to be eligible for the EV payment.

But a realbuyer will often have more than one specific product or service in mind that he is planning to possibly buy or more than one specific seller that he is planning to buy from.

For instance, Reece might have 5 dentists in mind that he will probably buy from. Likewise, a realbuyer might have in mind 5 different digital cameras that he is seriously considering for purchase. He might still use EVSPQ-RB, in order to find some alternatives.

Thus, it can be useful to enable a searcher to enter more than one name at the same time, for example, the names of five different dentists or five different cameras. The EVSPQ-RB can then pull all matching offers. If the EVSPQ-RB is a pay-for-placement embodiment, the offers can be sorted according the payment amount.

The EVSPQ-RB could further include means for pulling all the offers from sellers who name all search terms that Reece entered. Thus, if Reece were to buy from any of the five dentists she entered, then she would be eligible to be paid under the offers that the EVSPQ-RB presents. In other words, the EVSPQ-RB would find and present all the offers that have as a condition that Reece buys from one of the dentists that Reece entered.

2G. Method for Enabling Jobseekers to Tailor Offers to Realbuyer Employers

An employer is a type of buyer, a buyer of employment services. So the application of Ser. No. 10/042,975 enables jobseekers to pay for the attention of realbuyer employers.

We should note that the invention of Ser. No. 10/042,975 can include payment offer forms for enabling a jobseeker to specify various aspects of the job being sought, but several key aspects were disclosed in the “Additional Conditions” section of that application.

Other important conditions that the EVSPQ-RB can enable a seller (jobseeker) to include are:
years of experience
specified credential
specified schooling.

These conditions further specify the service to be bought by the realbuyer employer. So, let us note that the invention of application Ser. No. 10/042,975 can include steps in the payment offer process (fields in the payment offer form) for specifying those conditions as part of a realbuyer payment offer directed at realbuyer employers.

For example, an accountant could enter an offer to pay realbuyer employers who plan to buy the services of accountant+MBA+CPA+10 years experience+in Cleveland+within 6 months. A realbuyer employer would be eligible for payment-for-attention if he made a hire matching those criteria.

2H. Method for Enabling Employers to Pay Job Seekers for their Attention

Application of Ser. No. 10/042,975 did not disclose methods for enabling employers to easily tailor/describe payment-for-attention offers made to jobseekers.

Here we disclose that an EVSPQ can include a specialized payment offer form for tailoring/describing a special kind of payment-for-attention offer aimed at jobseekers. That is, the invention provides steps for entering novel conditions that define a novel payment-for-attention offer to jobseekers. Below we disclose these conditions.

But, let us first digress and discuss the “mirror-image” search problem that employers and qualified jobseekers face. An employer wants to find highly qualified job candidates. Yet most employers (or their agents) have to wade through piles of resumes and engage in an interview and other costly steps to qualify a job candidate. On the other side, a highly qualified job candidate wants to distinguish himself from, less qualified candidates. A job candidate will often have to expend great effort to demonstrate his qualifications—and since those are self-proclaimed, they are often suspect.

So, what is needed is a sort of like a litmus test, a magic touchstone, so to speak, for determining, with a minimum of effort, whether a candidate is highly qualified for a job.

Such a test would be a boon to employers who could direct their job solicitation messages only to those highly qualified candidates. And, such a test would be a boon to highly qualified candidates who could, in effect, wear the results of the test like a badge, so that employers could identify and reach those candidates, and even pay for their attention.

No one has come up with such a test, although is a holy grail in the job market. Here we disclose a test that, while not perfect, is novel, and possibly effective in partially achieving the goal of this magical touchstone/litmus test.

The key, qualifying condition of this test is that the candidate must land a job, defined by the advertiser, within a specified period of time.

For example, if an advertising employer is looking for an accountant, a jobseeker would be eligible for payment for attention to the employer's message if the jobseeker lands an accounting job, defined by the employer, within a specified period of time, say, six months.

With this condition in place, the employer/advertiser can be reasonably sure that the candidate is both looking for a job and is qualified enough to be hired by another employer.

(We note that payment-for-attention offer could also pay the candidate if the employer paying for the candidate's attention also hires the candidate. But this aspect is beside the point of the qualification test we disclose here.)

Accordingly, the invention provides a method (fields in a payment offer form) for enabling an employer to describe a job that a candidate must be hired for within a specified period of time, in order to the candidate to be eligible for payment for attention.

As a further test of a jobseeker's qualifications, an advertising employer might want to specify that, in order to be paid for attention, a jobseeker must land a job with a given organization or organizations, within a specified period of time.

For example, an Citibank might want to pay for calls to jobseekers who are qualified enough to be hired by Morgan Stanley or Goldman Sachs investment banking trainee program. So, Citibank could offer to pay $50 EV for calls from anyone who, by some date in the future, is hired for the trainee program at Morgan Stanley or Goldman Sachs.

Accordingly, the invention provides a method (fields in a payment offer form) for enabling an employer to describe a job such that a candidate must be hired for that job by a specified organization or organizations.

### Part 3

### In an EVSPQ-RB, Limiting EV Payments that Apply to a Specified Purchase

Contents of Part 3

3A. The Problems of Limiting EV Payments that Apply to a Specified Purchase

3A1. Problem: How to Limit Payments Made for a Single Purchase

3A2. Why Limit Payments

3A3. Problem of Time Spacing of Acceptances

3A4. Accepting Payments for the Same Purchase But for Different Types of Attention

3A5. Problem of Different EV Payments for the Same Purchase

3A6. Problem of Determining What the Prospect Is Searching For

3A7. Problems and Solutions Apply Where Organization Realbuyers Are Paid

3A8. Illustrative Example of Profusion of Payments for a Single Purchase

3B. Whether an Acceptance Matches a Purchase Is a Subjective Judgment

3C. Solution Methods that an EVSPQ-RB Can Include

3C1. “Just Browsing” Mode

3C2. “Same Search” Mode

3C3. Basing Inspection Charges on the Number of Acceptances in a Time Period

3C4. Using an Acceptance Tally to Adjust the Probability of an Acceptance Winning

3C5. Using Specificity in Searches and Acceptances

3C6. Basic Sequence of Steps for Limiting EV Payments for a Purchase (Transaction)

3C7. Using Machine Matching to Find Acceptances that May Apply to a Purchase

3C8. Person Mediated Method for Matching Payments that Apply to a Purchase

3C9. Apply the EV Payment Limit Rules to the Set of Matched Acceptances

3C10. Adjusting Payoffs Based Upon the Number of Acceptances for a Purchase

3A1. In an EVSPQ-RB: How to Limit Payments Made for a Single Purchase

The inventive methods to be disclosed in Part 3 apply to an EVSPQ-RB embodied as a directory in which payment offers are presented under search criteria.

Such a directory may be a pay-for-placement directory or a directory that presents offers using some other sorting rule(s).

For example, assume that Paul enters the search term notebook computer into the directory, and the directory returns three payment offers, each offering an EV payment to Paul for looking at a different web page ads for notebook computers.

And, assume that Paul accepts all three offers, and views all three ads, and further, that he provisionally wins a payoff from one of these EV payments.

Now, let us also assume that to collect the payoff he must show that he actually bought a notebook computer within a required period of time after he viewed the ads.

As disclosed in U.S. utility application Ser. No. 10/042,975, the conditions of an EV payment offer can act as offer identifiers/descriptors, and hence, the search criteria that are used to find an offer. For example, notebook computer can describe an offer, and can be used to find the offer, and can act as the buying condition for the offer.

Indeed, in implementations of the EVSPQ-RB that enable recipients to use a search form for finding offers, the offer conditions will probably be the favored parameters (criteria) for identifying/describing and searching the offers.

Further, the key test for being eligible for a payment in an offer found via an EVSPQ-RB directory is that the user makes a purchase (transaction) that matches the search criteria that the user entered to find the offer.

This test poses a fundamental problem: a purchase can be described in a multitude of ways. So, advertisers can place offers for the same purchase under many different descriptors/identifiers/criteria. And, likewise, a user searching for a product to purchase, that he eventually buys, can describe that product in many ways and, therefore, find and accept a large number of payment offers that match the purchase.

For example, if a user is searching for ads about notebook computers, he might enter notebook, laptop, mobile computer, lightweight computer, ultra-light computer, portable computer, Thinkpad, to name just a small number of possible search terms (for brevity, we leave aside the other variable descriptors, such as price and location information, that can further describe a purchase).

Any product or service can be described in a multitude of ways. So, assuming a user searches an EVSPQ-RB directory before making a purchase, and is exposed to multiple sales messages via the directory, and ultimately makes a purchase that searched for: how can EV payments to this user be limited?

3A2. Why Limit Payments

Why should payments-for-attention to a prospect be limited, assuming that the prospect buys a certain product, or from a certain seller, as specified by the payment offers?

One reason to limit payments is that it deters users from gaming the system, from trying to collect as many payments as possible, simply for the payments, and not out of interest in the messages of sellers.

The amount a seller can pay will depend on the seller's conversion rate, which will be low if searchers can collect unlimited payments.

Further, most sellers will not want to expose themselves to users who game the system.

Another important reason to limit payments is that, in the marketplace, many EVSPQ-RB systems may exist; just as many commercial search directories exist. The problem with multiple, competing EVSPQ-RB directories is that a prospect can use multiple directories, collect multiple payments, and thereby exceed the limit of any one directory, thus decreasing the efficiency of all the directories and payment offers collectively.

In fact, a collection of EVSPQ-RB's can be considered as one large database system, and that acceptance records from these databases can be pooled for the purpose of limiting payments per sale, and for the purpose of deterring cheating that can arise in many ways.

So, when we refer to the EVSPQ-RB in the singular, we also mean a collection of EVSPQ-RB which, at least, exchange or pool acceptance histories in some way. By pooled acceptance histories we mean that a particular user's history in each EVSPQ-RB is pooled from each database. (Acceptance histories can be pooled more globally as well to yield global statistics that can be used for a variety of purposes.)

The inventive methods disclosed below apply to these pooled acceptances.

Also importantly, we can assume in most cases that all the methods discuss apply to a group of EVSPQ-RB's that pool data, especially acceptance histories, including payoff records.

Pricing Solution

All this said above, one possible solution to the problem of limiting payments is not to limit payments, but to rely on the pricing mechanism, that is, to allow sellers to set the amount offered to realbuyers and let those amounts be determined by average searcher behavior. This method, though, damages the efficiency of the system because it leads to lower payments, on average, and increased searching.

Before disclosing methods for solving the problem of limiting payments-for-attention per sale, let us elaborate on some sub-problems, which the inventive methods will also address.

3A3. Problem of Time Spacing of Acceptances

In natural searching behavior, a user will often re-do a search for a product or a seller, or simply conduct a search spaced out over time.

Further, a realbuyer payment offer, will often stipulate a time limit for making a purchase, so a user will often be forced to re-do a search, and accept an offer more than once. For instance, if a user searches for a notebook computer and accepts an offer, but does not buy the computer for, say, six weeks, he may feel that he needs to re-do the search just before he buys, because his original acceptances may be expired.

The point is that multiple, similar or identical acceptances can occur over time, given the nature of searching, and the nature of how people buy (with somewhat unpredictable timeframes, even when they intend to buy).

So, the time spacing of a search can be another reason for an abundance of payment acceptances that apply to the same purchase, assuming that a purchase is made.

3A4. Accepting Payments for the Same Purchase but for Different Types of Attention

An EVSPQ-RB can enable a seller to pay for various kinds of attention, such as attention to a web page and/or a phone call. Thus, a realbuyer might get paid for viewing a website about a notebook computer, and get paid for making a call to a notebook computer seller.

A seller may not want to allow a realbuyer to get paid for more than one kind of attention. Thus, the terms of the seller's offer may stipulate that Paul can only get paid for one kind of attention.

Or, a seller might treat different kids of attention as completely separate.

Or, a seller might stipulate that a payment for one kind of attention can influence the payment for another kind of attention.

The possibilities are various.

Having different payments for different kinds of attention can complicate the problem of how to limit payments for a single purchase.

3A5. Problem of Different EV Payments for the Same Purchase

Different sellers can and will offer different amounts of payment under the same search criteria. And, sellers can and will offer different amounts of payment depending on the search criteria used. For example, the amount offered under the term computer would usually be different than then amount offered under notebook computer, which will be different than the amount offered under Thinkpad, and so forth. Different payments for different search criteria, all of which can match the same purchase, say, the purchase of a Thinkpad, can complicate the problem of how to limit payments for a single purchase.

3A6. Problem of Determining what the Prospect is Searching for

A user might engage in searches that match two or more similar products. Thus, the acceptances from these searches can apply to more than one product.

For example, a user might be searching for one notebook computer for his mother and another for himself. He might then enter a variety of similar terms, perhaps, even duplicating his search. Yet, he might only buy one computer.

If the user only buys one product, he may have a large number of acceptances that appear to apply to that purchase, but that, according to the searcher's intent, do not actually match that purchase.

What to do in this situation, where the realbuyer has excess acceptances that were not meant to apply to his purchase?

3A7. Problems and Solutions Apply where Organization Realbuyers are Paid

The payment limitation problems described above also arise in situations where a realbuyer is buying for an organization. So, the solution methods disclosed here can be used when an EVSQP-RB is used to pay organization realbuyers for their attention.

3A8. Illustrative Example of Profusion of Payments for a Single Purchase

Below we provide one example of how a simple search can lead to a profusion of EV payments for a single Purchase. We use this example for the sake of illustration, not to limit the invention in any way. Let us assume that Paul's 4 year-old daughter needs to have a teeth cleaning and that Paul needs to find a dentist. He searches using the criteria (search terms) below, and he clicks on, say for simplicity, just one link under each set of criteria.

Rather than show a full, hypothetical link, we will just show a hypothetical EV payment amount that corresponds to an offer under each set of search criteria:

| | |
|---|---|
| 1. Dentist + Scottsdale: | $0.30 EV |
| 2. Children's Dentist + Scottsdale: | $0.50 EV |
| 3. Pediatric Dentist + Scottsdale: | $0.45 EV |
| 4. Dentist + North Scottsdale: | $1.00 EV |
| 5. Children's Dentist + North Scottsdale: | $2.00 EV |
| 6. Pediatric Dentist + North Scottsdale: | $2.25 EV |
| 7. Dentist + 85255: | $0.50 EV |
| 8. Children's Dentist + 85255: | $3.10 EV |
| 9. Pediatric Dentist + 85255: | $3.05 EV |
| 10. Dentist + McDowell Mountain: | $3.00 EV |
| 11. Children's Dentist + McDowell Mountain: | $4.00 EV |
| 12. Pediatric Dentist + McDowell Mountain: | $3.60 EV |
| 13. Best rated Kid's Dentist + 85255: | $1.00 EV |
| 14. Best rated Kid's Dentist + McDowell Mountain: | $1.75 EV |
| 15. Best rated Kid's Dentist + North Scottsdale: | $1.90 EV |
| 16. Best rated Dentist + Scottsdale | $0.80 EV |
| 17. Family Dentist + 85255: | $1.50 EV |
| 18. Family Dentist + McDowell Mountain: | $9.00 EV |
| 19. Family Dentist + North Scottsdale: | $4.00 EV |
| 20. Smiles by Design + Scottsdale: | $10.00 EV |
| 21. McDowell Mountain Dentistry + Scottsdale: | $12.00 EV |
| 22. Dr. Robert Scheer + Scottsdale: | $15.00 EV |
| 23. Dr. Marc Zannis + Scottsdale: | $15.00 EV |

Under each search term, above, there may be multiple offers that Paul could accept. For simplicity, we are assuming that he clicks on only one offer per set of search criteria.

Let's further assume, although it is somewhat unrealistic, that Paul has repeated this search and clicked on the same acceptances 4 weeks after his did his first search.

So, there will be a total of 46 acceptances that can apply to the same purchase of teeth cleaning services.

Now, let us assume that Paul finds a dentist 5 days after his second search, and takes his daughter to get her teeth cleaned there—makes a purchase, that is. And let's assume he uses Dr. Marc Zannis, in the McDowell Mountain area, which means that the offer presented under the criteria Dr. Marc Zannis is a valid acceptance. The acceptances presented under Dr. Robert Scheer and Smiles by Design are invalid because Paul did not purchase from either dentist.

We assume that the McDowell Mountain area is in the 85255 zip code. This means that all the other acceptances above match the purchase that Paul has made. So, there are potentially 42 valid matches. This depends on the time frame of each offer, though. If the offers all expire, say, within 10 days after Paul selects them, then only half will be valid.

The point of the illustration is that a profusion of matches can be considered valid, and further, that determining whether an acceptance matches a purchase will often require a human understanding of language. Further, what is not shown is that Paul's searches and acceptances can happen within a context of many other searches and acceptances, which would all be recorded in Paul's acceptance history. So, the 46 acceptances above could be scattered throughout an extensive acceptance history.

How, then, to detect the valid acceptances that match his purchase, in order to limit the acceptances—the EV payments—that Paul can collect for a single purchase?

3B. Whether an Acceptance Matches a Purchase is a Subjective Judgment

Before disclosing solutions to the problem of limiting acceptances for a single Purchase, let us discuss procedures for determining whether a match exists between an acceptance and a purchase. That is, let us discuss the procedure for determining whether a purchase fulfills the conditions of a payment-for-attention offer that has been accepted.

The key condition of such an offer is: the user must purchase a product or service that is the subject of the offer by a specified date.

The offer will define/describe the product or service—describe a purchase, really.

Under the assumptions of an EVSPQ-RB directory, in which offers are found under search criteria, the criteria will describe/define the product or service. For example, a pediatric dentist might use terms such as dentist, dental services, kids dentist, children's dentist, or Dr. Robert Sheer (one of the dentist's competitors) to describe the purchase that must be made in order for a prospect to be eligible for payment.

A purchase can be defined in an infinite number of ways.

Likewise, the rules for deciding on whether a match exists are usually subjective, usually requiring a human judge to interpret. For example, if a 19-year old purchases the services of a dentist, does that purchase match an acceptance defined by the terms kids dentist?

Certain conditions are “objective” as in the time period that a purchase must take place. But the conditions of a realbuyer offer that define a product or service (a purchase) will usually need to be interpreted by a person to determine whether a purchase matches the offer terms of an offer acceptance. In other words, rules for judging whether a match exists will be governed by meta-rules that are outside the system, but that are applied by human inspectors who enter their judgments into the system, designating the matches that apply to a purchase.

3C. Solution Methods that an EVSPQ-RB can Include

The illustrative example of Section 3A8 shows how there can be a profusion of acceptances that match a purchase (transaction).

3C1. “Just Browsing” Mode

The EVSPQ-RB can enable a user to state that he is “just browsing,” and that during this browsing state, his acceptances of payment offers—such as clicking on presented offers—should not be recorded as acceptances.

A “just browsing” mode is useful because it reduces the number of acceptances.

Accordingly, the EVSPQ-RB can include a “toggle button” the user can press to designate that he is “just browsing” or “accepting offers.” Or, the system can default to assuming that the user is just browsing, unless the user “signs in,” stating that his acceptances should be recorded as valid acceptances.

Further, the system can enable the user to set a minimum payment for a valid acceptance, such that an acceptance below the threshold is not recorded as a valid acceptance, whereas an acceptance above the threshold is recorded as a valid acceptance.

3C2. “Same Search” Mode

The EVSPQ-RB can enable a user to state that his current search is for the same product (or same seller) as the previous search. Then, each acceptance under the “same search” would have a flag indicating it was the “same search” as the previous acceptance. This kind of designation can make it easier for a machine algorithm to group and tally acceptances, and make it likewise easier for an inspector who is reviewing a user's acceptance history.

3C3. Basing Inspection Charges on the Number of Acceptances in a Time Period

One way to encourage a person to use a “just browsing” mode is to charge the user for an inspection based upon the number of acceptances in the user's acceptance history, which the inspector must review, when the user makes a payoff claim.

Further, the system can include the method of providing the user with feedback telling the user how many offers he has accepted—how many acceptances have been recorded in his acceptance history—over a specified period.

3C4. Using an Acceptance Tally to Adjust the Probability of an Acceptance Winning

Another method an EVSPQ-RB can include is to adjust the probability that a given acceptance will win its EV payment bet, by using the number of acceptances over a period of time in a probability adjustment formula. This formula could operate automatically.

Instead of a formula, the system could provide the searcher with a tally of acceptances over a specified period of time, and further provide the searcher with a measure of whether his number of acceptances is above or below average, and by how much.

Using this feedback, the searcher could then set the probability of winning, per acceptance.

Adjusting the probability of winning can be useful in cases where there is a profusion of acceptances, and in cases where it is costly to inspect an acceptance history. If, for example, a searcher has 2,000 acceptances over a two-week period, then it might be quite costly for an inspector to review these acceptances, particularly if there are many winning acceptances. So, a solution is to decrease the probability of winning, thereby making the payoff larger, per win, and decreasing the number of payoff claims that an inspector has to match against the acceptances in the user's acceptance history (see sub-section 3C7).

3C5. Using Specificity in Searches and Acceptances

The most powerful approach for addressing the problem of too many acceptances does not involve adding a method to the system, but instead involves the searcher's strategy of accepting offers. The searcher can strive to accept only offers that are highly specific—that is, offers that are presented by the system in response to highly specific search criteria. Some examples below illustrate.

Assume the example of sub-section 3A8 above. Now, if Paul purchases a teeth cleaning from Smiles by Design in North Scottsdale (which we will assume not in the 85255 zip code or in the McDowell Mountain area), then 10 of the acceptances in the list above match that purchase (we can say there are 20 matches if the acceptances were repeated, as we assumed, but that is beside the point).

Finding out this “fact” requires scanning the list of acceptances and making a judgment per possible match. Further, the judgment requires a knowledge of the geographical areas specified in the acceptances, that is, an inspector would have to know whether Smiles by Design was located in the McDowell Mountain area. And this judgment could be subjective as well, since most local areas do not have precise boundaries.

So, the matching process can be potentially time consuming, making it desirable to find a way to limit the number of possible, subjective matches that need to be reviewed by a person.

One approach is for Paul to only accept offers that have highly specific descriptions of the product he will buy or of the seller he will buy from. For example, let us assume that Smiles by Design is in the 85260 zip code. This means that Paul's acceptances listing the 85255 zip code are non-matches. Further, a machine could determine this non-match easily. So, specificity has helped narrow down the list in a mechanical way.

“Degree of specificity” is usually a subjective idea, but still can be employed. Paul could have used a different kind of acceptance strategy, for instance. He could have narrowed down the list of dentists he might buy from by proper name, and then only accepted offers described by these names. Thus, his purchase from Smiles by Design would not match acceptances of offers identified by the proper names

Let us look at this principle in the case of a car purchase. Let us imagine that Paul wants to by a hybrid automobile. He could accept offer identified by the terms, hybrid car, hybrid auto, gas and electric car, and so forth. Alternatively, he could narrow down his choices to, say, a Toyota Prius and a Honda Civic Hybrid. Then, if he only accepted offers defined by these highly specific terms, the task of matching up acceptances would, in general, be easier than if he accepted offers defined by the more vague, broader terms.

This principle is clear when location descriptors are used. For example, let's assume that Paul is looking to rent an apartment on upper Connecticut Avenue in Washington, D.C. He could do a search using apartments+DC, apartments+northwest DC, apartments+DC+north Cleveland park.

Or, he could settle on a few possible buildings, for instance, 3457 Connecticut Avenue, 3780 Connecticut Avenue, and 4100 Connecticut Avenue, and accept only offers under those search terms. Then, all the acceptances would be easy to match up against his rental purchase. For instance, if he rents at 3780 Connecticut Avenue, then the acceptances under the other two addresses would be invalid, and the match judgment could even be considered mechanical (depending on the meta-rules of judging, which could then be translated into internal system-implemented algorithms).

Price is another specifier that demonstrates the principle of using specificity to limit the number of matchable acceptances. For example, assuming Paul wants to rent an apartment, he might accept offers defined by various price ranges. Let's assume he rents an apartment for $2,000 a month, then all his acceptances that include descriptors outside that price range—e.g., $1,000-$1,500 per month—would be non-matches, even if those acceptances were partly defined by (included) the address, 3780 Connecticut Avenue, that he rented at.

3C6. Basic Sequence of Steps for Limiting EV Payments for a Purchase

Before authorizing that the payoff on a claim be paid, an inspector may have to determine whether the payoff should be decreased due to Paul having exceeded the limit of EV payments for the purchase.

The invention provides a method for determining whether a prospect has exceeded the limit of EV payments for a purchase.

The invention further provides a method for adjusting a payoff if a prospect has exceeded the limit of EV payments for a purchase.

To determine whether a limit has been exceeded for a purchase, one must know about all the offers a prospect has accepted—all the acceptances—that apply to that purchase.

Under the EVSPQ-RB method of U.S. application Ser. No. 10/042,975, it is necessary to wait until an acceptance has won, and the user has submitted a payoff claim describing the purchase. Then, the user's acceptance history can be examined to find acceptances that match, apply to, that purchase.

Assumption

So, in disclosing methods for limiting payments, we assume that a user has submitted a payoff claim that describes the purchase that the user says he made, and that makes him eligible to collect the payoff.

Basic Steps

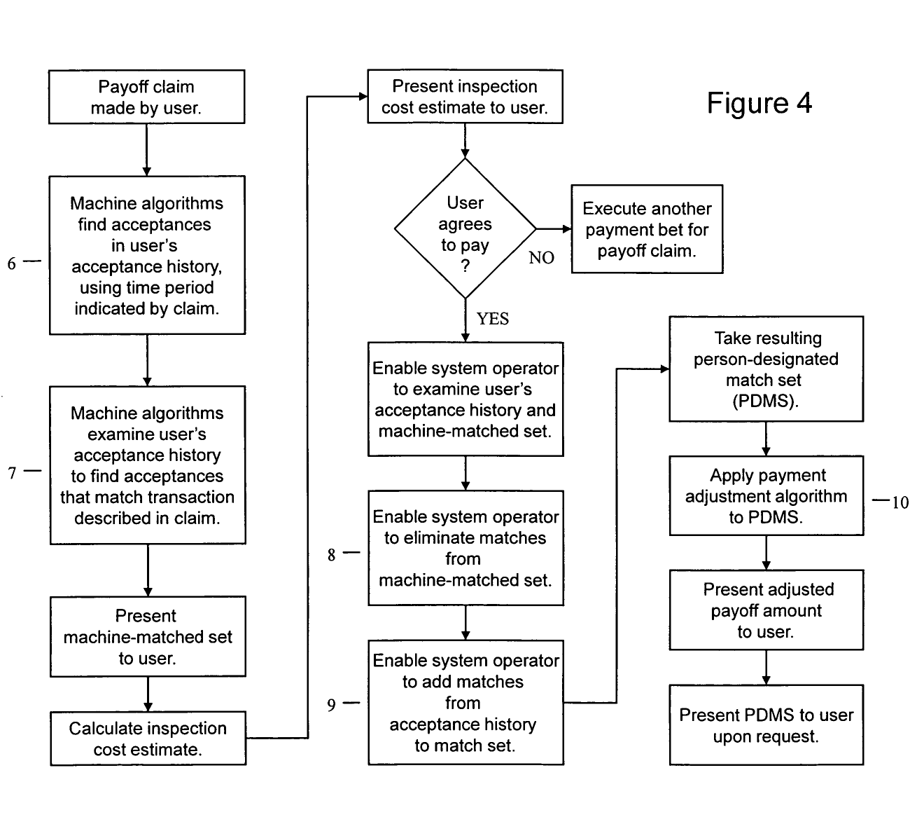

So, assuming a payoff claim has been submitted, describing a purchase, the basic sequence of steps that can be incorporated into the operation of an EVSPQ-RB, for the purpose of limiting EV payments for the purchase, are, as shown in FIG. 4:
1. Use (6), (7) machine matching to find acceptances that may apply to the purchase.
2. Use (8), (9) a human inspector to create a person-approved match set, by enabling the inspector to examine a user's acceptance history to eliminate false machine matches and to add matches that the machine missed.
3. Apply (10) the EV payment limit rules, adjusting (decreasing) the payoff, as set forth in the rules, if the EV payments of the acceptances exceed the limit in the rules.

We elaborate on these steps below, but first we discuss the concept of limiting payments.

Note about Multiple Winning Acceptances

We do not describe the case of multiple winning acceptances because the methods disclosed below can be extended to accommodate multiple winning acceptances in which a user claims more than one payoff for a single purchase.

Digression: Defining a Limit of EV Payments that can be Accepted for a Purchase

Rules for limiting EV payments that apply to a purchase can be highly variable.

For example, a limit can be a static number of EV payments. A limit can be an amount of EV payment in dollars. A limit can be a percentage of a purchase amount. A limit can be weighted to favor acceptances with higher EV payments.

A limit rule can incorporate the dates of payments.

A limit rule, or a set of limit rules, can be far more complicated than these mechanical schemes. For example, the meta-rules of the system can define a hierarchy of payments, in which, for instance, payments corresponding to more specific acceptances can take precedence over payments corresponding to less specific acceptances. The possibilities are infinite, so we cannot describe a preferred set of rules.

Instead, we can say that the system will have a set of meta-rules for limiting EV payments for a purchase.

Some of these meta-rules will have to be applied to an acceptance history by a system operator who interprets the rules. For example, assume that a user submits a payoff claim that describes the purchase of the service of a dentist having filled a child's cavity. And assume that one acceptance in the user's acceptance history is defined by the term: children's doctor. Now, does this acceptance match the purchase? At this time, machines cannot judge such a question well; only a person can.

Some of these meta-rules can and will be translated into a machine-executed algorithms that are applied to an acceptance history to find valid acceptances that possibly match a purchase. For example, a machine rule can determine whether an acceptance has expired, given the date of a purchase.

3C7. Using Machine Matching to Find Acceptances that May Apply to a Purchase

Assuming a payoff claim has been submitted for a winning acceptance (the claim including a description of a purchase, including the date of the purchase), the invention provides a method for triggering algorithms for finding the set of acceptances in the user's acceptance history that might apply to the purchase.

That is, the EVSPQ-RB can include algorithms for automatically finding a set EV payment offers that were accepted, and that could potentially have been eligible for a payoff on the purchase, if the acceptances had been winners.

The date range of the algorithmic search through an acceptance history will depend on the date reported for the purchase and upon the dates of expiration of the various acceptances in the user's acceptance history.

As noted, the key problem with a machine-matching algorithm is that it cannot judge well whether an acceptance matches a purchase.

That said, it is possible for the meta-rules of acceptances to be so constrained that machine algorithms can have a reasonable accuracy.

Thus, we note that it is possible to only use a machine matching algorithms for finding a match-set of acceptances that apply to a purchase.

Further, compared to the cost of a machine process, it is costly for an inspector to match acceptances to a purchase. It would be cheaper if no human matching had to be done.

But, how can the system solve the problem that a machine does a poor job of finding all the acceptances that match a purchase?

A solution is to use an extrapolation formula that estimates how many acceptances match a purchase, based upon the matches that the matching algorithm has found.

Such a formula can make use of the data in the user's acceptances, and can make use of global acceptance statistics from many users' acceptance histories.

The extrapolation formula would increase or decrease the number of acceptances found. An increase or decrease could be linear, in the sense that a factor is multiplied by the acceptances, and by the expected value of those acceptances. Or the formula could be far more complicated, yielding the virtual creation or destruction of acceptances, or pieces of acceptance data. We cannot describe the form of an extrapolation formula because the possibilities are infinite, and will depend on the particular implementation. (For instance, an extrapolation formula could be developed via a “genetic, evolutionary programming method” which would yield a formula that programmer's themselves could not create.)

In most cases, an extrapolation formula will be far less accurate than a human assisted match process at finding the acceptances that match a purchase. But, the cost advantages may be so great that users will accept this inaccuracy and seeming unfairness.

Thus, the invention also provides a method of using a match extrapolation formula to be applied to a set of machine-matched acceptances, to increase or decrease the number of matches, and to add or subtract from the value of the matches, if any are added or subtracted.

3C8. Person Mediated Method for Matching Payments that Apply to a Purchase

When a payoff claim is submitted, an inspector has the job of inspecting whether a winning acceptance validly matches the stated purchase.

A second job the inspector can have is to examine the winning user's acceptance history to determine which other acceptances match the purchase.

In order to enable the inspector to judge the matches, the inspector must ask the system to find all matches in the date range that the payoff claim indicates, that is, in the date range indicated by the date of the stated purchase. As discussed above, this date range will depend upon the implementation and upon the terms of acceptances in a user's acceptance history. (Date ranges may be standard in some implementations.)

Accordingly, the invention provides, in an inspection process, for a method of enabling a system authorized person, who we will call an inspector, to:
1. examine a set of acceptances that may match a purchase described in a payoff claim
2. designate acceptances that the inspector judges to be valid matches, acceptances that were eligible to be paid off for the described purchase.

This method comprises the steps of:
finding the acceptances in a user's acceptance history from a date that precedes, by a specified number of days, the date of the purchase described in the user's payoff claim,
enabling the inspector to designate any found acceptance as matching the purchase,
grouping the designated matches in a set called a person-designated match set (we use the term person rather than inspector just to emphasize that a human has judged the matches rather than a machine algorithm).
   Note about FIG. 4

The basic steps above are shown in FIG. 4, but FIG. 4 shows a more complicated process. We realize that the process of FIG. 4 can be simplified, and that all the steps shown in FIG. 4 are not essential, and will not necessarily be used in practice.

Having an Inspector Examine a Machine Matched Set of Acceptances

As discussed in sub-section 3C7, the system can include matching algorithms for finding acceptances that possibly match a purchase. Such algorithms can aid an inspector. Accordingly, the invention provides a method for enabling an inspector to invoke algorithms for matching acceptances in a user's history to a claimed (stated) purchase.

Further, the invention provides a method for enabling an inspector to find and designate a set of acceptances as matching a claimed purchase, comprising the steps of:
system algorithms checking a user's acceptance history and finding the set of possibly eligible, possibly matching acceptances, according to the date of the claimed purchase, and the date terms of the acceptances in the user's acceptance history
system algorithms finding (7) a set of possible matches, according to the description of the claimed purchase, the terms of the winning acceptance, and the terms of the other acceptances being checked, yielding a machine-matched set of matching acceptances,
enabling (8) an inspector to delete possible matches from the machine matched set,
enabling an inspector to examine the full set of possibly eligible, matching acceptances,
enabling an inspector to add matches from the full set of possibly matching acceptances to the machine matched set, yielding a set of person-designated matches.
   Enabling a User to Approve the Cost of Examining the User's Acceptance History

If an inspector examines the user's acceptance history, the exam will cost money.

This can be paid in various ways. One way is to charge the user for the inspection.

If a user can be charged, then the invention can also provide a method for providing the user with a cost estimate for the exam.

The system can, thus, include a cost estimating algorithm that evaluates the size of the acceptance data to be examined, and generates an exam cost estimate. The system then outputs this cost estimate to the user before enabling the inspector to examine the user's acceptance history to designate matches.

The system can further include steps for enabling the user to agree to pay the estimated cost or reject the estimate, or ask for an appeal of the cost.

For cases where the user rejects the estimate, then the system can include the step of executing another bet for the claimed payoff, in which the expected value for the user equals the claimed payoff, with this extra bet payoff set high enough to justify the cost of examining the user's acceptance history.

Saving Labor by Randomly Sampling of the Set of Matched Acceptances

A user's acceptance history may be quite extensive, making it costly for a person (an inspector) to review. One solution to this problem is to enable an inspector to randomly sample the acceptance history, selecting 1/N acceptances to review. If the inspector finds that a selected acceptance is a match, this acceptance can be multiplied by N, in the sense that it can be assumed that there are N more acceptances like it in the user's acceptance history. That is, each match found will represent N other matches. For example, if N=4 then it is fair to assume that each selected match represents 4 matching acceptances, the one selected and three that are not. Of course, this assumption may not be accurate, but it is a fair assumption.

By using sampling to amplify the selected matches, enough labor can be saved to reduce the inspection cost to a minor amount.

Accordingly, the invention provides, in an inspection process, for a method of reducing the number of acceptances to be matched by an inspector, comprised of the following steps:
finding the full acceptance history of a user's acceptances stored from a date that precedes, by a specified number of days, the date of the purchase described in a user's payoff claim,
randomly selecting acceptances from the set with a probability of 1/N,
enabling the inspector to examine these randomly selected acceptances,
enabling the inspector to designate an acceptance as matching (applying to) the purchase,
if the inspector designates an acceptance as matching the purchase, then multiplying the expected value (EV) and other multipliable aspects of the acceptance by N, such that the resulting set of matching acceptance is increased by N acceptances that are equivalent to the selected and matching acceptance(s).
   Letting the User Find the Set of Matching Acceptances

It is also possible for the system to include steps for enabling a user to find and designate matches. In other words, it is possible to enable a user to act as the inspector.

This method is vulnerable to cheating. But, the cheating can address by enabling the inspector to audit the user's designations.

Accordingly, the invention provides a method for enabling a user to act as an inspector of his own acceptance history to detect acceptances that match the user's purchase, described in his payoff claim.

Further, the invention provides a method of enabling an inspector to audit the user's judgments and to penalize the user for misjudgments.

In other words, a person assuming the role of inspector, for the purpose of finding acceptance-purchase matches, can be the user making the payoff claim.

3C9. Apply the EV Payment Limit Rules to the Set of Matched Acceptances

Assuming that system algorithms and/or an inspector has/have designate a set of matched acceptances then, as shown in FIG. 4, the invention provides a method of applying (10) the EV payment limit rules to this set to yield an adjusted payoff

(If the limit has not been exceeded, then no adjustment is necessary.)

The system then presents to this adjusted payoff to the winning user.

Further, the invention also provides a method for enabling the user to agree to this adjusted payoff or to appeal the adjustment to the payoff. Such steps would include showing the user the set of matched acceptances upon the user's request.

(The adjusted payoff may be below a user or system specified threshold, in which case another bet can be executed where the EV of the bet=the adjusted payoff, yielding a zero value for the payoff claim, or a larger, adjusted payoff.)

As noted a great variety of limit rules are possible. We give three examples to illustrate.

A limit rule could be based on the raw number of matching acceptances. Assume then a limit called L, and total number of acceptances, M, then, the payoff could adjusted by a formula of:
if the number of acceptances is greater than L, then Payoff owed to user=(L/M)×(Payoff from winning bet).

Another limit rule could be based on the percentage of a purchase amount that is allowed. Assume then a limit, L, and a total, a summed percentage of all the acceptances in the match set, Q, then, the payoff cold be adjusted by a formula of:
if the total, summed percentages of a purchase amount is greater than L, then Payoff owed to user=(L)/(Q)×(Payoff from winning bet).

Another limit rule could be based on the value of matching acceptances, such that a limit of acceptances, L, is set, and then the top L acceptances in terms of EV could be selected from the matched set. Using this kind of algorithm, the winning acceptance could be eliminated entirely, leaving the user with no payoff.

3C10. Adjusting Payoffs Based Upon the Number of Acceptances for a Purchase

Using EVSPQ-RB a seller offers a payment to realbuyer prospects for attention. For example, let's say Sela is a dentist and she offers Paul $5 EV to call her if he is ready-to-buy dental services. How much should she offer? There are many factors to consider. One important factor is Paul's searching behavior, that is, how many other dentists he calls. In general, the fewer dentists he calls, the higher the probability is that he will buy from Sela.

And, the higher probability is that he will buy from Sela, the more she can pay him for his attention. So, it would be useful to enable Sela to adjust the amount of her payment offer based upon how many other sellers Paul has contacted. In terms of EVSPQ-RB, that means it would be useful to enable Sela to adjust the amount of her payment offer based upon how many offers Paul has accepted.

It is possible to enable Sela to adjust her offer by enabling her, in the seller process, to enter an adjustment formula that boosts and/or lowers the amount of EV payment based upon the number of Paul's acceptances. Such a formula can be infinitely variable, so we cannot describe a preferred formula.

For example, Sela could set, as part of the terms of her offer, the following adjustment formula condition: “If the user accepts more than 5 pay-the-caller offers, my payment offer is reduced by 50%.” As another example, she could include the following adjustment formula condition: “My payment offer will be reduced by 10% for every other offer the user accepts that matches the purchase defined in my offer.”

Accordingly, the invention provides a method of operating an EVSPQ-RB for the purpose of enabling a seller to increase or decrease the value of a payment-for-attention offer based upon the number of offers a user has accepted that match a defined purchase; this method being comprised of the following steps:
In the seller process, enabling the seller to enter an adjustment formula into the seller offer form, the adjustment formula taking the number of offers a realbuyer accepts that match the purchase specified by the seller's offer, and using this number of matching acceptances to yield an adjustment factor to the payoff of the seller's EV payment offer.
In the prospect process, showing the adjustment formula, when the seller's offer is presented to the prospect.
In the inspection process, finding the number of matching acceptances and then applying the adjustment formula to yield an adjusted payoff.

We note that an adjustment formula does not have to be custom-created by a seller; it can be a rule of the system, standard across seller offers.

Now, a realbuyer prospect can game this kind of adjustment formula by contacting sellers who do not have offers listed in the EVSPQ-RB, but the capability to vary a payment amount, via such a formula can still be highly useful.

Further, the formula can applies to specially defined offer acceptances, in the sense that the seller can define the meaning of a matching offer. The possibilities for defining matches are innumerable, of course. To give just one example, Sela could say that the adjustment formula only applies to offers that have been accepted in which the product or service or seller described in the offer has been identified with a proper name (which would be a way of defining offers that are fairly specific).

Accordingly, the invention provides a method for enabling a seller to enter an adjustment formula, and to enter custom definitions of what it means to for user's acceptance to match the purchase defined in the seller's offer, such that the adjustment formula is only applied to the custom-defined matches, that is, to the accepted offers the seller has defined.

### Part 4

### Embodiments for Registering Acceptances of Pay-the-Realbuyer-Caller Offers

Contents of Part 4

4A. What Is Described in Part 4, Assumptions, Definitions

4B. Click-to-Call Directory in which Switch/Bridge Calls Recipient and Seller

4C. Click-to-Call Directory in which a Recipient's Browser-Phone Calls the Seller

4D. Method for Enabling a Seller to Call in Response to a Recipient's Acceptance

4E. Methods for Accommodating Missed and Misdirected Calls

4F. Method for Using Guarantees to Ensure a Caller's Intention to Buy

4G. Method for Call Logging Using Caller Reporting Followed by Auditing

4A. What is Described in Part 4, Assumptions, Definitions

In Part 4 we describe methods to be incorporated into an EVSPQ-RB that enables a user to accept an offer to paid for calling a seller (a call to a recorded message or to a person). These registration methods are covered by application Ser. No. 10/042,975, which disclosed the basic steps for registering that a recipient is accepting a pay-the-realbuyer-to-call offer.

The embodiments described below follow these steps but employ different phone system tools than those described in application Ser. No. 10/042,975. We include these embodiments in this specification in case they are useful for patenting purposes.

Additional methods are disclosed for enabling a seller to initiate a call in response to a recipient accepting a pay-the-realbuyer-to call offer.

In Part 4, we assume an EVSPQ-RB directory, which can be a pay-for-placement directory or a non-competitive directory, as defined above in “How this Specification Is Written.”

The embodiments and methods described in Part 4 are designed to be incorporated into the operation of this kind of directory.

A seller enters a pay-the-realbuyer-to-call offer into such a directory. The offer includes the seller's destination phone number and various offer details.

We assume that a seller enters her offer at an EVSPQ-RB website that is the front-end for entering offers into the directory.

We will sometimes call a seller Sela and a recipient (prospect) Paul.

We describe how the EVSPQ-RB directory can enable users to register acceptances of pay-the-realbuyer-to-call offers. In the marketplace, we assume that this kind of offer will be the most prevalent kind of pay-the-caller offer. However, we note, importantly, that most of the methods described can apply where an advertiser desires to make a pay-the-qualified-person-to-call offer. Realbuyers, in other words, are not the only kind of qualified person that can be paid to call. The inventive method and system can be used to pay qualified users who meet the qualification set in an EV payment-for-attention offer, as transacted by an EVSPQ. So, where an EVSPQ-RB is used below, one can usually substitute just EVSPQ, the broader invention of application Ser. No. 10/042,975.

4B. Click-to-Call Directory in which Switch/Bridge Calls Recipient and Seller

In this section we describe how an EVSPQ-RB can incorporate the use of a specially configured phone switch/bridge that takes offer acceptance data from the EVSPQ-RB database, and uses this data to make a call to a seller and a call to a prospect and then bridges those two calls.

In describing this embodiment, which we call a Click-to-Call Directory in which Switch/Bridge Calls Recipient and Seller, we will use the same steps as disclosed in U.S. application Ser. No. 10/042,975. When we say, “Remains the same” below, we mean that we have nothing to add to the steps disclosed in application Ser. No. 10/042,975. Further, when we say prospect process, seller process, and inspector process, we mean the processes disclosed in application Ser. No. 10/042,975.

We will describe a directory embodiment, in which the directory presents links that represent offer—that is, identify offers, provide data for connecting a call and, provide data for registering acceptances of offers.

We note that a directory is not necessary for this registration method. A link can be on a website that a user arrives at by any means. Thus, a link on a website can be considered equivalent to a link presented via a directory. The link simply must include instructions that are equivalent to the link instructions described below.

For illustration's sake, we will assume Sela has entered a pay-the-realbuyer-to-call offer into an EVSPQ-RB, and has used the search criteria dentist and 85255 to identify her offer.

We further assume that Paul has entered these same criteria and that the EVSPQ-RB has presented him with a list of matching offers, including Sela's offer. We assume that Paul triggers the acceptance of Sela's offer by clicking on the link that corresponds to her offer.

Assuming this kind of directory front-end for enabling a user to accept such an offer, and to initiate a call, we will describe how the EVSPQ-RB can employ a switch/bridge that calls Sela and Paul separately and bridges the call between them.

By switch/bridge we mean a programmable system that receives the two phone numbers and can call each party separately and then bridge the calls together, and can further register data about the connected call, such as the duration of the call. Such switches/bridges are well known and can take a variety of forms.

A switch/bridge needs two numbers to connect. The seller's number will be provided from the information in a link, and the prospect's number will be provided from the directory, which will have captured and stored the prospect's number, e.g., in a user account or by a querying the prospect's number. That is, the directory would have to capture the prospect's number, which could be done when Paul registers his ID data with the directory or done in a separate query made to Paul, e.g., via pop-up web-form. The numbers are sent to the switch by the directory or by the prospect's browser, which captures the numbers from the directory.

Thus, each link presented by the directory will be a well-known, “push-to-talk” link that contains instructions for enabling a browser to send information to the switch/bridge, or instructions for enabling the directory to send information to the switch/bridge.

Further, the link can provide payment offer data to the switch, so that the switch can associate the connected call with the payment offer that Paul has clicked on.

This payment offer data—that is, data that identify the terms of the offer that we in effect at the time that the prospect accepted the offer—can vary depending on the implementation. The data can be an offer ID. It can be a full set of the offer data valid at the time the link is clicked on (which may be useful since offers will change over time).

Actually, the offer data may not have to be provided because the offer may be uniquely identifiable by the seller's phone number+the prospects phone number (or ID)+a timestamp corresponding to when the prospect clicked on the link. The combination of these three pieces of data may be enough, for the EVSPQ-RB central database (directory) to associate a connected call with the offer that was accepted, and that initiated the call. Thus, the switch/bridge may simply store this data in the call detail record.

So, as noted, to enable a call to be connected, and for acceptance data to be associated with the call, the directory or browser would need to provide Paul's phone number, Sela's phone number, and offer identifying data, and communicate all these data to the switch/bridge.

These data can be communicated to the switch/bridge by the directory, upon a link being selected, or via the browser, which can capture the information from the link. The method of communicating with the switch will depend on the implementation.

Such a bridge/switch can be integrated with the EVSPQ-RB directory, or the directory can communicate with the switch/bridge, which would be a “separate” entity. We will assume that the directory and the bridge/switch communicate, although the alternative configuration is equivalent.

After a call is connected, the call detail record+offer identifying data would be sent back to the EVSPQRB central database, which would store the combined record in the acceptance record for the offer that Paul selected.

So, assuming the directory has Sela's and Paul's numbers, then when Paul clicks on Sela's offer Paul's browser would capture all the information described above from the link and communicate this information to the switch/bridge (or the browser would trigger the directory to communicate the information to the switch/bridge). The switch/bridge, having the necessary information, would then call both phone numbers and bridge the call.

After connecting the call, the switch/bridge would send the combined call detail record+offer identifying data to the EVSPQ-RB database.

Further, the bridge/switch could have a list of authorized seller numbers, which would correspond to seller accounts. These authorized seller numbers can be provided by the directory to the switch in a separate operation (not shown in any figures). Then, the switch could connect only calls to sellers that have valid accounts.

To recap, when a link is clicked on, which means an offer is selected/accepted, the prospect's phone number and the seller's phone number must be transmitted to a switch/bridge so that the switch/bridge can connect the prospect and the seller on a call. After the call is connected, the switch/bridge needs to send this call detail record back to the EVSPQ-RB database so that the EVSPQ-RB can execute the rest of the prospect process. Further, the EVSPQ-RB must associate this call detail record with the offer that the prospect selected. This association can be accomplished in various ways, as discussed above.

Below we repeat and elaborate on the steps just described above that an EVSPQ-RB performs in this embodiment, which we will call an EVSPQ-RB Using an Click-to-Call Bridging Switch that Calls Recipients and Sellers. Below we follow the steps/format of application Ser. No. 10/042,975. So, to repeat, when we say “remains the same” we mean that we have nothing to add to the disclosure of that application, which we incorporate by reference.

The Seller Process (of Application Ser. No. 10/042,975)

In the click-to-call directory communicating with a bridge/switch embodiment, Sela enters her offer into EVSPQ-RB through a website interface, using an offer form. Below, we describe the data she enters and how EVSPQ-RB uses it to enable Paul to accept her offer.

Field 1: Name Used by the Seller for the Offer Document

Remains the same.

Field 2: Data for Enabling Prospects to Find an Offer

In the case of an click-to-call directory, communicating with a bridge/switch, the data for finding and accepting Sela's offer is a lookup code or search criteria specified by Sela that corresponds uniquely to an offer from her. (If a directory is not used, Sela's offer can be a presented on a website, or via a non-directory, voice interface, and the offer can be accepted by clicking on a link or issuing a voice command. In these cases, data for finding the offer would be outside the system, for the user would find the offer by arriving at the website.)

Field 3: Data for Accessing the Advertising

Sela's phone number is the key data for accessing Sela's advertising. The phone number is presented by the EVSQP-RB directory as a link (the number may be visible or not). Additional data may be necessary to access the advertising (and is necessary for registering an acceptance of Sela's offer), such as an offer ID associated with the link that Paul clicks on. When Paul clicks on the link, he initiates the call and triggers an acceptance of the offer. A full acceptance will require a completed call meeting conditions specified by Sela's offer.

Field 4: Amount of EV Payment

Remains the same.

Field 5: Realbuyer Conditions

Remains the same.

Field 6: Controls

Remain the same.

Steps for Enabling Payment by a Seller

Remain the same.

The Prospect Process (of Application Ser. No. 10/042,975)

1. Register the Prospect's Identity and Phone Number.

The exact method for identifying Paul depends upon the implementation. A directory can identify a prospect by a password, cookie, or other well-known login methods, which enables the system to use pre-stored ID data for the user, including the user's phone number. Alternatively, the system can query Paul for his current phone number.

2. Find the Offer.

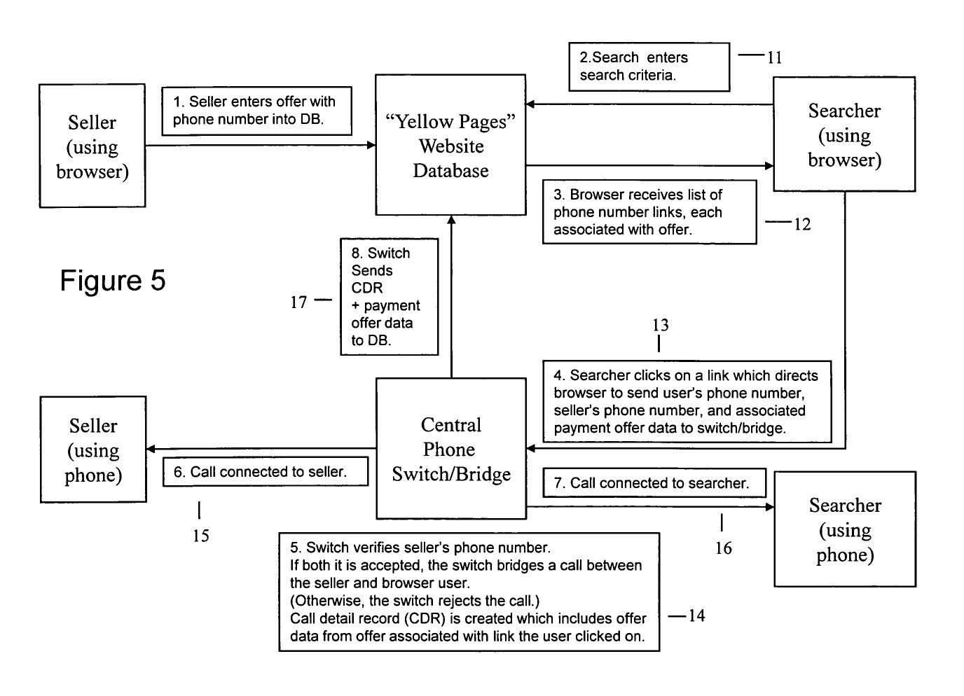

As shown in FIG. 5, Paul enters (11) search criteria that match Sela's RB offer. The directory presents (12) Sela's offer.

3. Connect the Prospect to the Seller's Advertising (Send Necessary Data to Switch).

Paul selects (13) the offer (clicks on the offer link, or issues an equivalent command, such as a voice command). Paul's selection of Sela's offer triggers the initial registering of an acceptance, and causes the directory or browser to send Paul's and Sela's numbers to the switch/bridge, along with the offer identifying data. The switch verifies (14) that the Sela's number is on a list of valid seller accounts, and if so, calls Sela (15) and calls Paul (16) and if both pick up the calls, bridges the calls together.

4. Register Duration of the Call.

The switch registers the time/date and duration of the call. This data enables the seller to be charged toll charges, if they apply, and enables EVSPQ-RB to verify that Paul has paid enough attention to qualify for the EV payment Sela has offered.

5. Send Call and Offer Data from Switch/Bridge to EVSPQ-RB Database

The switch sends (17) the following data to the EVSPQ-RB central database (where the rest of the prospect process is executed) including:
a. Paul's phone number
b. Paul's identity data, if the phone number is not enough,
c. possibly, the search criteria or other data that identified the offer
d. possibly, the details of the RB offer that has been accepted, triggering the call,
e. Sela's phone number
f. Sela's account information, if the phone number is not enough
g. the duration of his call,
h. the time/date of the call.

As noted, that the switch my not store the details of the payment offer, but only enough information to identify the offer, along with a timestamp. In other words, the switch sends a call detail record plus enough details of the offer that Paul has selected/accepted, so that the rest of the prospect process can be executed.

The registration of the connected call signifies an acceptance of Sela's offer. Other tests of a valid acceptance are possible, as described in Section 4E below.

6. Possibly, Register Toll Charges to the Seller.

If there is a toll charge, which will usually be the case, EVSPQ-RB will also assess a charge to be paid (in most cases) by Sela based on the duration of the call. The charge is registered to Sela's account.

7. Verify Realbuyer Conditions, in Particular, that Attention is Paid.

We assume that Paul must spend a threshold amount of time on the call to Sela's number in order to collect his EV payment. Sela may set the threshold as part of the terms of her RB offer, or the threshold may be standard. Thus, EVSPQ-RB checks if the duration of the call is greater than the threshold. If it is not, EVSPQ-RB does not register an acceptance. If Sela sets the threshold then EVSPQ-RB must identify the offer and compare the duration of Paul's call with her custom threshold, as specified in the offer data.

Another realbuyer condition, discussed above, is that Paul must call during a certain period in the day, e.g., during business hours. Thus, if this condition applies EVSPQ-RB can check whether Paul has met it as well. If he has not, EVSPQ-RB does not register an acceptance.

8. If Enough Attention is Paid, Register an Acceptance.

If the duration of the call is greater than the threshold required, EVSPQ-RB registers the acceptance of Sela's offer in an acceptance record. As noted, EVSPQ-RB identifies the offer by the lookup code.

9. Apply the Rule in Effect Regarding Multiple Acceptances.

Remains the same.

10. Select a Random Number from a Range Dictated by the EV Payment and the Payoff (or the Payoff Multiple).

Remains the same.

11. Record the Results of the Random Number Generation.

Remains the same.

12. When the Time Requirement has Expired, Inform the Acceptor that he has Won.

Remains the same.

13. Receive and Register Claim.

Remains the same.

14. Pass the Claim to the Inspector Process.

Remains the same.

Payment Steps in the Prospect Process

Remain the same except for the addition, depending on the implementation, of assessing toll charges to sellers. Where Paul accesses Sela by phone through the EVSPQ-RB switch, toll charges will usually apply. If so, these charges need to be paid by someone. There are various ways to assess these charges to users. One way is to assess the charge to Sela.

The Inspector Process

Remains the same.

Payment Processes for Paying a Payoff

The possible processes for transacting EV payments into a payoff remain the same.

Producing Seller Reports

Remains the same.

4C. Click-to-Call Directory in which a Recipient's Browser-Phone Calls the Seller

Embodiment in which Browser-Phone Communicates with Switch that Passes Call Detail Records to EVSPQ

In this section we describe another method for registering acceptances of a pay-the-realbuyer-to-call offer, and for connecting the corresponding call. This method employs a browser-phone, and so, does not require that the prospect use a phone that is separate from the computer he uses to find and accept the offer.

A browser-phone is a phone that includes a browser, or a browser that includes a phone.

This embodiment uses well-known click-to-call methods employed by browser-phones. The additional steps we describe are for associating an offer acceptance with a call record.

In describing this embodiment, we will assume the same scenario as in the embodiment in Section 4B—that is, Sela has entered an offer into an EVSPQ-RB and Paul has found and accepted the offer by clicking on it. We will describe the embodiment from this point.

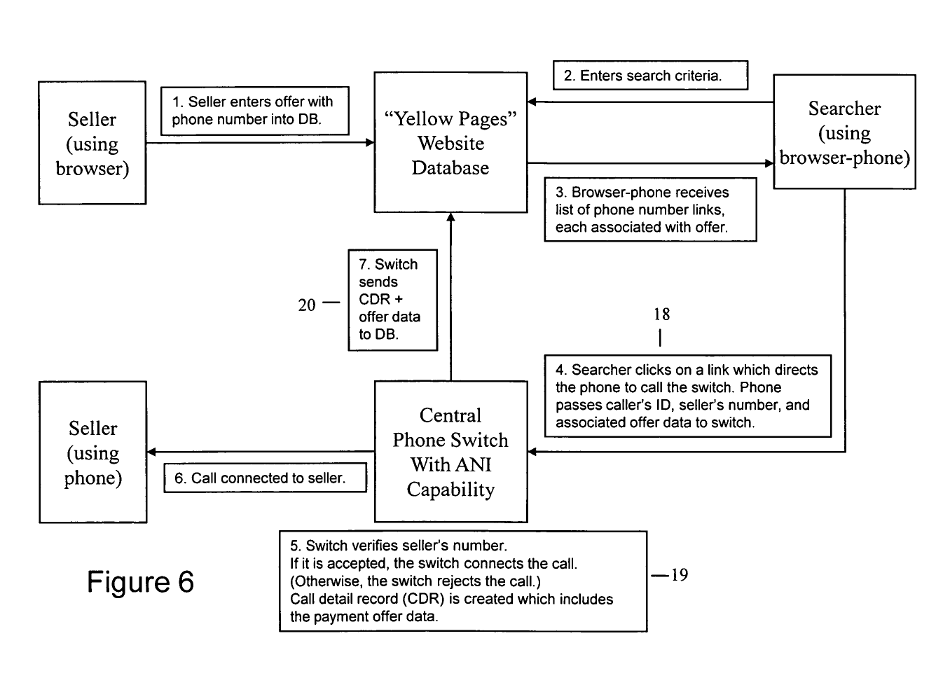

As shown in FIG. 6, Paul selects Sela's offer, causing the browser-phone to call a phone switch, which connects the call to Sela.

The browser-phone captures the seller's number from the link that Paul clicked on, and captures offer identifying data, as discussed in the embodiment of Section 4B, and passes (18) Paul's and Sela's phone numbers and offer identifying data to the switch.

The switch connects the call and creates (19) a call detail record.

As in the embodiment of 4B, the switch can include a list of authorized seller numbers, and can block calls to unauthorized numbers.

The switch passes (20) the call detail record plus the associated offer identifying data back to the EVSPQ-RB central database, which continues executing the prospect process.

We note again that the data identifying the offer acceptance that is associated with a call can vary depending on the implementation. We note, again, that the two seller and prospect phone numbers, combined with the timestamp of the call or the timestamp of when Paul accepted the offer, may be enough to uniquely identify the terms of the offer that the prospect accepted when he clicked on the phone link presented by the EVSPQ-RB.

Embodiment in which Browser-Phone Passes Called Detail Record to EVSPQ

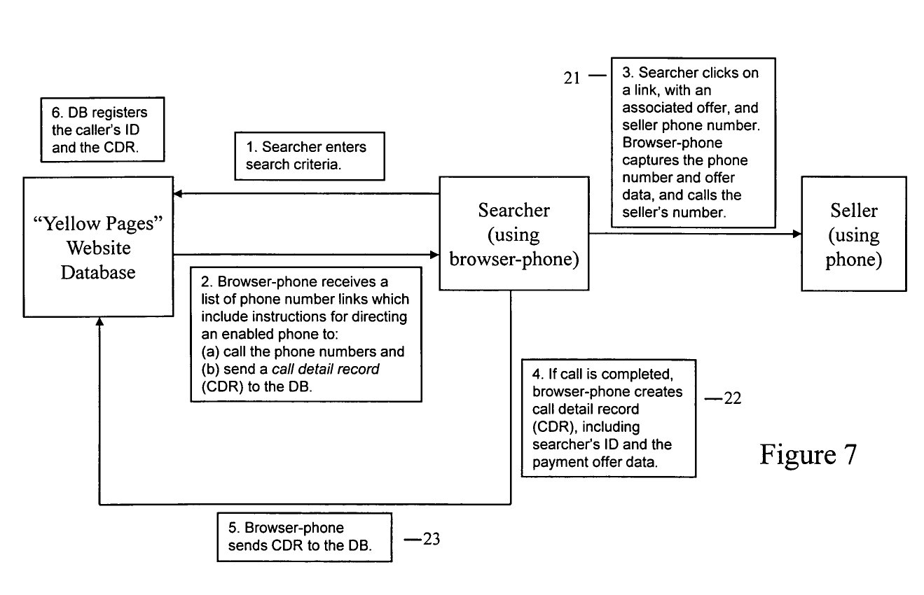

As shown in FIG. 7, an alternative embodiment is one in which the browser phone clicks on a link, captures (21) the corresponding seller phone number, and seller offer data, and calls the seller.

If the call connects, the browser phone creates (22) a call detail record, including offer identifying data, and sends (23) this call detail record to the EVSPQ-RB, which adds this record to the corresponding acceptance record that the EVSPQ-RB then uses to continue executing the prospect process.

4D. Method for Enabling a Seller to Call in Response to a Recipient's Acceptance

In the preceding embodiments, a prospect accepts an offer, triggering the connection of a call. An alternative is for a prospect to accept an offer and request that the seller who made the offer respond by calling the prospect, possibly during a specified time period.

To enable this kind of interaction to take place, the system stores the prospect's acceptance and request in an acceptance record. The acceptance is partial at this point.

Further, the system presents the request to the corresponding seller, for instance, in a seller account page, or a “page” where sellers would see call requests.

A call request would show the prospect's phone number, the time period that the prospect requested that a call take place (if any), the terms of the offer that is accepted, and the search criteria that the prospect used to find the offer.

For example, assuming Sela's offer is found under dentist+zip code 85255, and offers to pay $2 EV for Paul to talk to Sela, and assuming that Paul has found and selected the offer, and assuming Paul's number is 480-555-1234, then the call request would post all these facts for Sela to view. And further, the system would enable Sela to “click on” (select) Paul's number to connected a call to that number.

Assuming that the system presents this kind of call request, the system must enable the call to be placed, logged and associated with the acceptance record. Methods have been described above for doing these things in the case of a prospect placing the call. If the seller places the call the basic methods are the same, except that the seller can use the click-to-call connection and logging methods described, and the switch/bridge, switch, or seller's browser can communicate the call detail record, associated with the payment offer, to the EVSPQ-RB central database, which continues executing the prospect process.

Assuming a prospect accepts a pay-the-realbuyer-to-call offer by requesting a call from a seller, using an EVSPQ-RB to register the acceptance, then the invention can provide a method for operating an EVSPQ-RB, comprised of the following steps:
logging (registering) the acceptance and request-for-a-call, including:
   1. the prospect's phone number,
   2. preferred time of receiving a call from the seller,
   3. offer terms at time of the acceptance,
   4. the search criteria, if any, that the prospect has entered into the directory to find the offer that he accepted,
posting the acceptance in the seller's account so that the seller can see the request, including the prospect's phone number, preferred time of receiving a call from the seller, and including offer terms at time it was accepted, and including search criteria, if any, that the prospect has entered into the directory to find the offer,
enabling the seller to “click-to-call” on the missed-call number, and registering the connection, if any is made, as an acceptance of the realbuyer payment offer associated with the recipient's original call (acceptance),
registering the duration of the completed call,
if the duration and other call data meets the requirements of a valid call, recording the connected call as a valid acceptance of the associated pay-for-attention-to-a call offer.
   4E. Methods for Accommodating Missed and Misdirected Calls
   Problem

In a pay-the-realbuyer-caller method and system, one problem that arises is missed and misdirected calls. That is, a prospect can be connected to a seller's destination number, which the seller has listed in his realbuyer payment offer, but the prospect may reach voicemail or may reach the wrong person in the seller's organization.

How, then, to register a valid acceptance of a pay-the-realbuyer-to-call offer when a call is missed or misdirected?

(Of course, if a caller is paid to reach a voicemail sales message, that is a different issue and not a problem.)

Defining a Missed or Misdirected Call

Let us give a definition of a missed or misdirected call, while realizing this definition does not limit the inventive method, but is helpful for the disclosure. Let us say that a missed or misdirected call is a call that does not connect a user (who has accepted an RB offer) to a person that the seller intended the user to be connected to.

Or we can say that a missed call is a call in which a user is connected to the seller's destination number, but is not connected with a person. And, we can say that a misdirected call is a call in which a user is connected to the seller's destination number, and speaks to a person, but does not speak to a person that the seller intended.

Seller Offer Form can Include a Field for Specifying Who the Caller Must Speak with

We note that in the seller offer process an EVSPQ-RB can include a field for enabling a seller to specify who a prospect must speak to in the seller's organization, in order for the prospect to be eligible for payment for the call.

Defining a Call Connection-and-Logging System

The pay-the-caller embodiments in sub-section 4B-4D above, and in application Ser. No. 10/042,975, all include a call connection-and-logging method.

To this method steps were added in application Ser. No. 10/042,975 for registering an acceptance for a pay-the-caller offer, and for storing the call detail record along with the acceptance record.

For convenience in the discussion below, we will refer to a system for registering call details and acceptance record details by the term connection-and-logging method and system, which will encompass all the embodiments already described in Sections 4B-4D, and other equivalent embodiments described in application Ser. No. 10/042,975.

Operational Test Methods for Detecting Missed and Misdirected Calls

How can an EVSPQ-RB register that a recipient has reached the correct person? A solution is to devise operational tests that the system can “administer” and that, when passed, signify that a call is properly connected, as required by the seller offer.

In other words, a solution is for the EVSPQ-RB to include steps for administering these tests, and thereby registering when a call is properly connected.

Test 1: Minimum Length of Time for the Call

As described in application Ser. No. 10/042,975, a seller can set a minimum time required for a call to last in order to be a valid call. This test can be applied by the system, which can disqualify acceptances for calls that last under the required limit.

Test 2: Time Period for a Call

As described in application Ser. No. 10/042,975, a seller can define a particular period of time of the day that a call must take place in order to be a valid call. This test can be applied by the system, which can disqualify acceptances for calls that are connected outside that period.

Test 3: Voicemail Detection

A suitably equipped connection-and-logging system can include means for detecting whether a call is connected to a voicemail box. Thus, a switch or a browser-phone used to connect a call can include means for detecting that a voicemail box has been reached, and can further include means for detecting whether a call was connected/transferred to a person.

The EVSPQ-RB can further include disqualify an acceptance if the associated payment offer requires that the call is transferred to a person, and if the detection means finds that the call is not transferred to a person.

Test 4: After-the-Fact Inspection of Recorded Call

A connection-and-logging system, such as a switch or browser-phone, can include means for recording all or part of the call, and storing the voice record in the acceptance record for the corresponding realbuyer payment offer. Then, if an inspection takes place, the inspector or a computer-executed algorithm can examine the acceptance record, playing back all or part of the recorded call, and detect whether the call was transferred to a person. The result of this detection operation can then be entered by an inspector, or automatically, into the acceptance record, possibly disqualifying the acceptance.

Further, a human inspector can also determine whether the caller spoke to the person that the seller specified, if any, in the realbuyer payment offer.

Test 5: Approval Signal by Seller

A connection-and-logging system, such as a switch or browser-phone, can include means for enabling a seller to “press a button” or take an equivalent action during a connected phone call to acknowledge that the pay-the-realbuyer payment is valid, i.e., that the realbuyer has reached the person, if any, specified by the realbuyer payment offer.

Thus, for example, a call can be connected between a recipient and a seller, and the seller can then press, for instance, ** on his keypad to indicate that the realbuyer payment acceptance is valid. If the ** approval signal is not pressed, then the acceptance is not validated.

If such a method were used, the acceptance record would reflect whether or not the seller approved the payment.

Further, such a method the system would store the validation or lack of validation in the acceptance record, thereby designating the acceptance as valid or invalid.

Further, the method and system can include additional steps for enabling a recipient to appeal if the seller rejects a payment.

Penalty Methods for Missed and Misdirected Calls

Missed and misdirected calls waste a recipient's time. So, an approach for reducing missed and misdirected call is to penalize the seller for a missed or misdirected call, if that call is made by the recipient within the time of day specified by the seller's RB offer.

The penalty can be a flat fee or a percentage of the seller's payment offer.

The penalty can be paid to the recipient.

Thus, an EVSPQ-RB can include steps for assessing a fee for a completed, yet missed/misdirected call, and for paying the fee, or part of the fee, to the caller (if the caller is a realbuyer, as required by the seller's realbuyer offer).

Missed and Misdirected Calls when a Seller Calls a Recipient

Section 4D described how the inventive method can enable a seller to initiate a pay-the-realbuyer call.

Even when a seller does not make the call first to a prospective realbuyer, the prospective realbuyer may call and leave a message. A seller will want to return the call.

A problem arises of how to pay for the call—register a valid acceptance—if the seller reaches voicemail or the wrong person in the prospect's organization.

The invention can provide a method for enabling a seller to call a prospect back who has made a pay-the-realbuyer call to the seller, and for the call-back to trigger the inventive system to register an acceptance of the realbuyer offer.

Assuming a recipient (a prospect) accepts a pay-the-realbuyer-to-call offer by placing a call using an EVSPQ-RB to register the acceptance, then the invention can provide a method for operating an EVSPQ-RB, comprised of the following steps:
logging (registering) the acceptance and connecting the call,
but, if the call misses the seller, the registering that the call was a missed call, and posting the miss in the seller's account so that the seller can see the missed call as, analogously, a user of a cell phone can see his missed calls,
enabling the seller to “click-to-call” on the missed-call number, and registering the connection, if any is made, as an acceptance of the realbuyer payment offer associated with the recipient's original call (acceptance),
registering the duration of the completed call,
if the duration and other call data meets the requirements of a valid call, recording the connected call as a valid acceptance of the associated pay-for-attention-to-a call offer.
   4F. Method for Using Guarantees to Ensure a Caller's Intention to Buy

In a pay-the-realbuyer-caller system, prospects will call and sellers may give those callers priority, and further, will usually devote a salesperson to taking the call.

A salesperson's time is costly, so ideally a seller would like its salespeople to focus their time on true realbuyer prospects.

The method of U.S. application Ser. No. 10/042,975 enables inspection of winning prospects to verify whether or not they are realbuyers, but this verification takes place probabilistically after the prospects have been exposed to a sales message, such as a phone conversation. The method does not pre-qualify callers, which leaves open a free rider problem of people calling and pretending to be realbuyers in order to get a human to take their call.

Sellers would like a tool for pre-qualifying each caller, a tool for knowing in advance of having a human take an incoming call, whether the caller is a realbuyer or not.

One way to deter the free rider problem, and to increase the chances that a caller is a realbuyer, is to enable a caller to pledge a bond (a guarantee) ensuring he is indeed a realbuyer. This bond would be forfeit if the caller turned out not to be a realbuyer.

A seller could then offer a user who pledges a bond a larger payment for calling than a user who does not pledge a bond. A seller might make a payment-the-prospect-for-calling offer only to callers who pledge such a bond.

Moreover, it can be highly useful, as a sorting mechanism, to inform sellers that a caller has pledged a bond. Thus, if the recipient of the payment initiates the call, then the system can, if it assists in connecting the call, inform the seller that the caller has pledged a bond, in advance of the seller picking up the call and talking.

It is also possible, as noted, to have the seller initiate the call, by having the system provide the seller with a list of recipients who have accepted the payment-for-a-call offer and who have also pledged a bond. If the seller initiates the call, then the system will require steps, as discussed above, for registering the call and transacting the payment. For convenience, we will assume that the caller initiates the call, while realizing that those skilled in the art will see how the steps disclosed can be modified to enable the seller to initiate the call.

Accordingly, the inventive method and system can include interface elements and process steps for enabling a seller to enter and display payment-for-attention offers (specifically, a payment-for-a-call offer) that are directed at:
a. realbuyer callers
b. realbuyer callers who pledge a specified bond guaranteeing their purchasing intentions.

And, correspondingly, the EVSPQ-RB can include interface elements and process steps for enabling a caller to accept the offer and put the required bond in escrow or otherwise pledge it. The system may or may not include a payment transfer process and an escrow process.

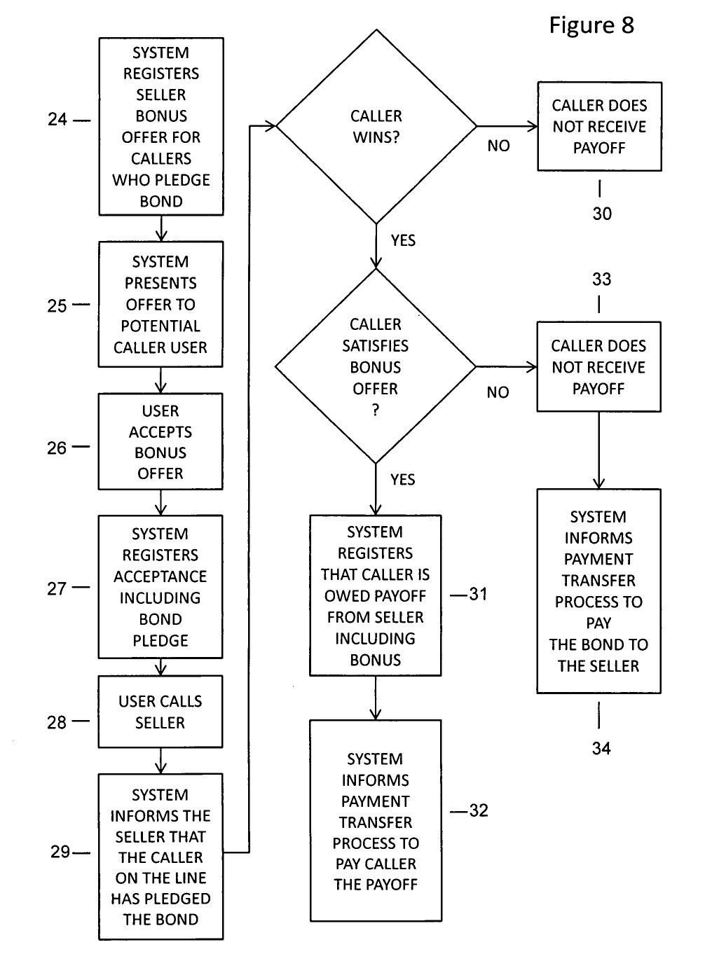

In one embodiment, as shown in FIG. 8, the EVSPQ-RB executes the following steps:
registers 24 a seller's EV payment offer, including a bonus for callers who pledge a specified bond,
presents 25 the offer to users who may call the seller,
when a user accepts 26 the bonus offer, the system registers 26 an acceptance by the user, including user's pledge to pay the specified bond if the user does not satisfy the conditions of the payment offer,
when the user calls the seller, the system informs 29 the seller that a bond-pledging caller is on the line (although this step is not necessary),
if the call is not connected, no payment is owed,
if the call is connected, in accordance with the payment offer, the system decides the EV payment bet,
   if the caller is not a winner, the caller does not receive 30 a payoff,
   if the caller is a winner, an inspection takes place to verify whether the caller met the conditions of the payment offer, and the system registers the result of the inspection:
      if the caller satisfies the payment offer conditions:
         the system registers 31 that the caller is owed the payoff, including the bonus payoff and informs 32 a payment transfer process to pay the caller the payoff.
      if the callers does not satisfy the payment offer conditions:
         the system registers 33 that the caller is not owed the payoff and informs 34 a payment transfer process to pay the bond from the caller to the seller.

The bond in the process above can be a definite payment.

Or, the bond can be offered in the form of an EV payment at the time of a call, i.e., the caller can offer an EV payment to the seller. Conveniently, the result of the EV payment bet can be determined by the same random number generation process as the EV payment bet that is executed for the seller's EV payment to the caller (although this is not necessary—the two EV payment bets can be separate). In other words, the seller can make a provisional EV payment to the caller, and the caller can simultaneously make a provisional EV payment to the seller. If the EV payment bet generates a winning result then a payoff is made from seller to caller, or caller to seller, depending on whether the caller turns out to be a realbuyer or not.

Alternatively, an EVSPQ-RB can include an audit method, separate from the EV payment method, in which callers are randomly audited, after making calls, to see if they are realbuyers. Callers who do not fulfill the terms of the realbuyer offer they accepted would lose their bond.

Alternatively, a small bond, per call, could be accumulated into an account, and if a caller is inspected as part of a realbuyer payment offer, and if the caller is found not to be a realbuyer, the entire accumulated pot could be confiscated.

This method for ensuring that a call is a realbuyer may turn out to be an efficient sorting method for separating tire kickers from realbuyers in advance of a sales conversation between a prospects and salesperson. It has been analogously disclosed in U.S. utility patent application Ser. No. 09/100,601.

The method can be used for sales messages that do not involve a live person on the seller's side, but it seems to apply best where a salesperson's time needs to be saved.

4G. Method for Call Logging Using Caller Reporting Followed by Auditing

When an electronic ad medium connects a call between a prospect and a seller, as in the switching systems discussed above, the call can be logged automatically by computer, which enables easy billing. A problem with ad medium switching systems, though, especially click-to-call systems as they presently exist in the marketplace, is that costs are often increased by added telephony charges. Sellers (advertisers) usually bear these costs.

Therefore, it can be advantageous to obviate additional switching systems, where a third party, like an ad medium, makes the connection, and instead just let prospects call sellers directly. However, in systems where the seller pays the prospect for the call, the call must be logged to provide a record for payment purposes.

One way to obviate an extra switching/logging system is via the use of cell phone system, in which a prospect calls the seller by cell phone. The cell phone service provider often logs each call and provides an itemized bill, a record that the call took place.

Yet in some phone systems, such as landline systems, calls may not be logged and itemized—in most phone systems, local phone calls are not itemized for customers.

Here we disclose a method and system for logging calls. This method and system enable a party on a call to report the call and enables auditing of that report.

This call method and system can be used in conjunction with any system that enables one party on a call to pay the other party for the call (the payer does not have to be a seller). Below we will assume that the receiver of the payment (the prospect) initiates the call and reports the call, but it is similarly possible for the payer to initiate and report the call.

Accordingly, the call logging method and system can be implemented within, or can send messages to, an EVSPQ-RB for the purpose of creating a record that enables payment from a seller (Sela) to a prospect (Paul).

We will assume that the method and system are implemented within an EVSPQ-RB, as an additional module and sub-process, but they can be partially outside the EVSPQ-RB, communicating with it.

An EVSPQ-RB with the call logging method includes interface elements for:
registering a user's intent to call a specified seller,
reporting that the call took place, and reporting a detail or details of the call that can provide proof of the call (a useful call detail, for example, is the name of the person that the caller spoke with).

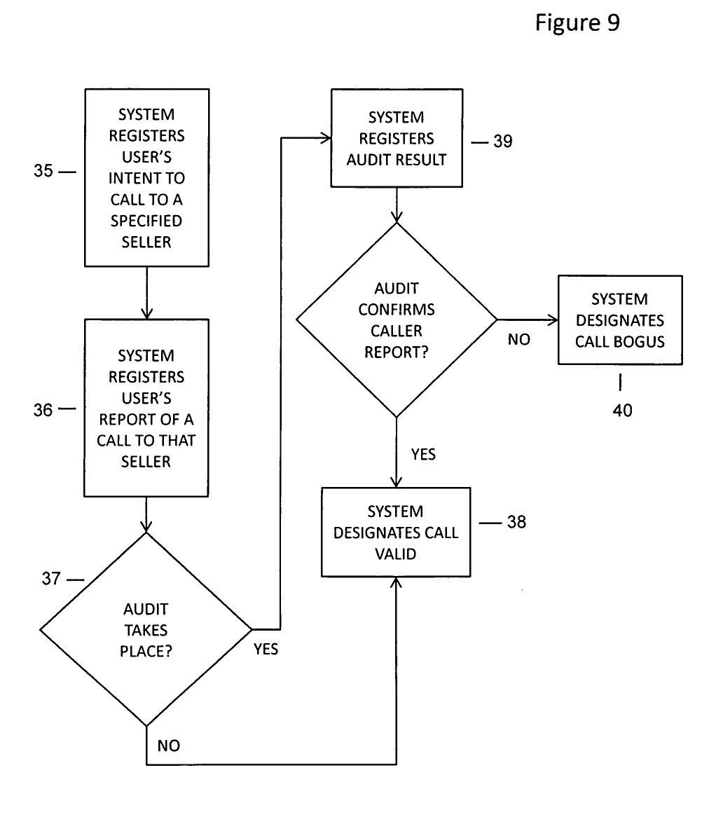

In this method, the system executes the following steps, as shown in FIG. 9:
registers 35 a user's intent to call a specified seller (e.g., by registering a click on a link or a voice command or equivalent action)
registers 36 a report by the user that the call has been made, the report may include descriptive details.

Some period of time after the call report, the system then:
determines 37 whether an audit takes place (the audit has some probability of occurring and can be determined according to a formula that may include a random number generation process).

The audit checks the information submitted in the call report. The audit can be done by calling up the seller and asking the seller to confirm the call report record. The call report record can include the caller's name.

A human or machine can do the audit, depending on the implementation. If a human does the audit, he enters the result into the call logging system. If a machine does the audit, the result can automatically be entered into the system.

If the audit does not take place, then the system:
designates 38 the call valid.

If the audit does take place, the system:
registers 39 the result of the audit.
   if the audit result confirms the call report entered by the caller, the system designates 38 the call valid.
   if the audit result does not confirm the call report entered by the caller, the system designates 40 the call bogus.

If the call is designated valid, the caller is owed the payment for calling. If the call is designated bogus, the caller is not owed the payment.

It is possible to use this call logging method without requiring the caller to submit a report describing the call. Instead, simply reporting that he made the call may be enough, depending on the implementation. In this case, the auditor would call the seller and ask if the caller actually made the call. This audit will only work if the auditor can give the caller's name, and if the seller takes names. It can be a meta-rule of the system that the caller must give him name and the seller is responsible for taking name.

As an additional or alternative set of audit steps, the system can present the call report records to the seller that was purportedly called. As noted, the call report records can include the caller's name. Further, the system can include interface means and steps to enable the seller to claim that any given reported call is bogus or valid.

For example, if Paul reports to the system that he called Sela, the system can show Sela the report. If she thinks she did not receive the call, she can claim that it is bogus.

The seller's determination is equivalent to the audit determination above.

The system can accept Sela's claim, and designate the call bogus, or it can include another review process.

Probabilistic Reporting Embodiment

Rather than making a caller report every call, it saves labor and may be more user-friendly to enable callers to report probabilistically.

One way this can is by auditing with penalties. The system can enable a user to signal that he intends to call a given seller, e.g., by clicking on the seller's advertisement.

Then, the system can wait a specified period of time, and with some probability (1/N), ask the caller to report the call, in which the caller submits evidence (discussed above) proving the call was made or, simply asserts that he made the call. For example, the system might ask the user to report a call 1 out of 10 times.

The user's report can then be audited. If the user's report does not pass the audit, he can be penalized.

An alternative way is to use the expected value payment method as follows. In this method, the system can enable a user to signal that he intends to call a given seller, e.g., by clicking on the seller's advertisement.

Then, the system can wait a specified period of time, and with some probability (1/N), ask the caller to report the call, in which the caller submits evidence (discussed above) proving the call was made or, simply asserts that he made the call. For example, the system might ask the user to report a call 1 out of 10 times.

In this method, the caller would be paid N times the amount he is owed for the call, if he reports the call, and if his report passes the audit. For example, if he is owed $1 EV for making the call, and he has to report 1 out of 10 calls, then for those calls he reports, and that pass the audit, he will be owed $10 EV.

He is owed nothing if he does not report the call.

### Part 5

### Methods for Transferring Payment in EV Payment and Verification Systems

This Part 5 is a copy of the Description of U.S. application Ser. No. 10/811,643, Methods for Transferring Payment in EV Payment and Verification Systems, referenced above, by the same author as this specification. The author includes this copy in case it is useful for patenting purposes.

In this Part 5, the invention and the inventive method will refer to the inventive methods described in this Part 5. Likewise, the invention and the inventive system will refer to the inventive systems described in this Part 5.

The methods described in this Part 5 apply to situations in which a payment system enables a payer to pay a recipient an EV payment provided that the recipient meets specified conditions that are verified and/or tracked using the system.

This Part 5 elaborates on a method of using two EV payment bets to transfer a payment from a payer, through a system, to a recipient. In this method, the payer takes the payoff risk in the first bet while the system takes the payoff risk in the second bet.

In addition, this Part 5 describes a method for paying an EV amount that is based on a percentage of a purchase amount. This description is included here for the sake of completeness, but has already been disclosed in the above referenced applications.

In addition, this Part 5 describes how EV payments can be capped when EV payment is based upon a percentage of a purchase amount.

In addition, this Part 5 repeats descriptions in one or more of the above referenced applications of how transaction costs can be reduced with the use of deposits.

Other sub-methods are described that have been included in one or more of the above-referenced applications.

Contents of Part 5

Introduction:

How the Specification of Part 5 Is Written
Where the Inventive Methods Apply
Inspection (Verification) Process Reviewed
Example Scenario
Definitions for Part 5
   (Note: “Sections” below refer to Sections of this Part 5)
Section 5A: Payer Takes All the Payoff Risk
Section 5B: System Takes All the Payoff Risk and Refunds Invalid Payoff Claims to Payer
Section 5C: Two-Bet Process Where Payer and System Take Separate Payoff Risk, in which the First Bet Payoff Is Deducted from Payer
Section 5D: System Takes All the Payoff Risk and Uses a Discount Formula to Adjust for Invalid Claims
Section 5E: Two-Bet Processes in Which EV Payment Equals a Percentage of a Sale
Section 5F: Using Deposits to Reduce Inspection Costs
Section 5G: Miscellaneous Sub-Methods for Efficient and User-Friendly Transactions

### Introduction

How this Specification of Part 5 is Written

This specification is organized as a set of descriptions of modules (sub-processes) that together comprise the inventive method. The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing database entities that communicate with each other.

The goal of this specification is to disclose the novel aspects of the inventive method and system. There is no ideal way to present these aspects, and so, those skilled in technical writing or programming will see better ways to organize and present this disclosure.

Example cases are provided. Those skilled in the art will know that these examples are illustrative only and do not limit the range of applications of the present invention.

Many of the options described in this specification, such as certain terms of EV payment bets, may be held standard in practice. Those skilled in the art will readily see where a user option may be converted into a default.

We omit descriptions of the various methods that the inventive systems can include for charging users because these methods are well known and do not add to the disclosure.

Where the Inventive Methods Apply

The methods described in this Part 5 apply in payment systems operated according to a method that enables a payer to pay a recipient an EV payment, if the recipient meets specified conditions, which are probabilistically verified and/or tracked using the system.

We call this method the expected value method for paying and verifying (EVMPV). We call an online database system operated according to the EVMPV by the name expected value system for paying and verifying (EVSPV).

The EVMPV is a method for operating an online database system comprising the following elements and steps that are tailored in novel ways to solve specific problems:
1. A payer ID and bank account are established
2. A system account bank account exists
3. A payer posts a payment offer in the system
4. The offer is findable and selectable (acceptable) by recipient who can thus submit a claim for the payment offered
5. A recipient account, including a recipient ID, is registered
6. A recipient's claim submission is registered
7. An EV payment bet is executed to determine whether the claim submitted is worth a payoff multiple of its original value
8. If the claim is a winner, the submitter is informed that the claim is provisionally worth the payoff of the EV payment bet
9. If the submitter claims the payoff from the bet, a payoff claim is registered and a system-authorized inspector verifies whether the payment offer conditions were met
   a. Upon a negative determination entered by the inspector, the system registers that, the payoff claim is disqualified
   b. Upon a positive determination entered by the inspector, the system registers that the claim is worth the EV payment bet payoff.

Methods and systems employing variations of the method above were disclosed in patent applications filed by the author, including patent application Ser. Nos. 09/536,727 and 10/042,975 describing a method and system for paying qualified audiences for attention to sales messages; patent application Ser. No. 10/424,190 describing a method and system for paying commissions to referrers and; provisional application 60/529,071 describing a method and system for paying targeted discounts to qualified buyers.

All these applications are incorporated by reference.

This Part 5 describes several methods for transferring payments from payers to recipients within an EVMPV and an EVSPV. This Part 5 does not concern itself with all the steps of an EVMPV, but with the payment transfer steps.

Note: In all cases below, if the EVSPV collects payment from payers, the EVSPV will include well-known debit and/or credit account processes. Further, the EVSPV will include well-known mechanisms for accepting payment and for notifying a payer and/or for suspending a payer's offer when her account has a low balance or an overdue balance.

Inspection (Verification) Process Reviewed

The EVMPV and EVSPV include steps for triggering a verification process, which we usually call an inspection process, and for registering the results of the inspection.

Let us briefly review an inspection process in the EVSPV so we can refer back to it.

When a user has submitted a payoff claim, the EVSPV (the system) will assign the claim data a status indicating that the claim data is to be examined by a system-authorized inspector. Thus, to enable an inspector to decide whether the user has met the offer conditions, the invention will provide a module for:
informing a system-authorized inspector that a claim is to be inspected,
enabling the inspector to inspect the claim data and,
enabling the inspector to view the corresponding payment offer.

The inspection will take place outside of the inventive system, and the inspector will enter the decision of the inspection into the system.

The system can enable an inspector to enter an inspection report explaining why he has rejected a claim, i.e., the system can include a standard menu of explanation options (like form-letter responses) that an inspector can select from to explain his claim rejection, or can enable him to enter a custom written explanation of his own.

If the inspector approves a claim, the system passes the inspector's decision to a payment transfer process for transferring the payoff to the user.

Example Scenario

In this specification, we will use a single scenario to make the methods disclosed clear.

For this scenario, we assume that an EVSPV is implemented within an online database that is a “service bureau” for more than one payer.

Second, we assume a payer, called BestSitter, that provides babysitting services, and that uses the EVSPV to make and transact payment offers.

Third, we assume that BestSitter has established a user account, including bank account.

Fourth, we assume the BestSitter posts three different kinds of payment offers: an offer to pay qualified prospects to view BestSitter's website, an offer to give a discount to qualified lower-income families, and an offer to pay people who refer in customers.

We note that the invention is not limited to this scenario or to the types of payment offers described in this scenario.

Definitions for Part 5

EVMPV. See above.

EVSPV. See above.

Payer. A person or organization (or an agent) offering an EV payment using the EVSPV. For convenience, also referred to as Paula.

Payer Bank Account. An account, maintained in the system, in which a payer deposits money (or a virtual account for keeping track of what the payer owes).

Payment Offer. An offer to pay a person or organization that meets/fits specified conditions a specified amount of money or a specified percentage of a sale (a sale is meant broadly to encompass any money or commodity transaction).

Recipient. A person or organization (or an agent) submitting a claim for payment. Also called a claimant. For convenience, also referred to as Reece.

System Bank Account. An account, maintained in the system for the system's money, to receive payment from payers and give payment to recipients (and possibly to send money to another system account for keeping system revenues).

Claim. A claim submitted for an EV payment corresponding to an EV payment offer.

Payoff claim. A claim submitted for a payoff from a winning EV payment claim.

Inspector. A system-authorized user who (1) decides whether a payoff claim is valid and (2) provides the inspection decision to the EVSPV.

### Section 5A

### Payer Takes all the Payoff Risk

How the EVSPV enables payoffs to be transferred from payers to recipients depends on who takes the payoff risk. In this Section A, we assume that the payer takes all the payoff risk.

If the payer assumes all the payoff risk that means that the payer has to pay the full payoff if a claim “wins” the payment bet that the EVSPV executes.

In this case, the system does not necessarily have to collect payment; it can be an accounting machine in the sense that it registers payment obligations but does not transfer actual payment. Thus, the system can include steps for notifying payers of their payment obligations and for notifying winning, qualified claimants that they are owed a payoff amount from a given payer.

For example, assume BestSitter is offering $10 EV to referrers, and assume that Ray, a referrer, wins $1,000 in the payment bet based on this offer, and assume that Ray meets the conditions of the offer. Then, EVSPV will notify Ray that BestSitter owes him $1,000 and will notify BestSitter that it owes Ray $1,000.

Alternatively, EVSPV can include a process for transferring payoffs from payers to winning, qualified claimants. This process includes steps for:
establishing a bank account for a payer,
receiving funds into in this account and,
transferring a payoff from the payer's account to a qualified claimant who has a winning, inspected, valid claim.
   Using a Two-Bet (“Parlay”) Process

Instead of using a single bet, an EVMPV and EVSPV can use a two-(or more)-bet process.

Accordingly, the invention provides a method for operating an EVSPV including the steps of:
execute a first bet in which Reece's payment claim has a given, first EV=x, and a First Payoff=y,
if Reece's claim loses this first bet, then set the claim value to zero, and do not continue executing bets for the claim,
if Reece's claim wins this first bet, then execute a second bet in which Reece's claim has an EV=y, and a Second Payoff=z,
   if Reece's claim loses this second bet, then set the claim value to zero, store the result, and do not continue executing bets for the claim,
   if Reece's claim wins this second bet, credit Reece's claim with provisional value=z.

One advantage of a parlay bet is that an initial bet payoff may not be enough to justify doing an inspection, but may justify inducing a claimant to supply payoff claim information, which can be used to set the terms of a second bet that has a higher EV and payoff than in the first bet (see Section E for an example case).

Another advantage of a two-bet process is that an EV payment claimant can be informed if he has won the first stage bet, and can be queried as to whether he meets the terms of the payment offers. The claimant's response can then be registered in a claims database and a user database.

For example, assume BestSitters offers Reece $1 EV if he calls BestSitters, and if he buys babysitting services within 2 weeks of making the call. And assume that Reece calls BestSitters, using an EVSPV that registers Reece's claim to the $1 EV.

Further, assume that this EVSPV executes a first bet in which Reece's claim has a payoff of $100 and a probability winning of 0.01. Further, assume Reece's claim wins this first bet.

Then, the EVSPV can query Reece and ask him if he indeed did buy babysitting services within two weeks of making his call to BestSitters. Reece can ignore the query, and the EVSPV can register this lack of response or, Reece can respond, “yes,” or “no,” and the EVSPV can register these responses as well.

If Reece responds, “yes,” then the EVSPV can execute a second bet. In this second bet, Reece's claim will have an EV=$100. Assume that the payoff is $500 and the probability of winning is 0.2. Finally, assume that Reece's claim wins this second bet, then the claim is provisionally worth $500, until an inspection takes place to see if Reece has met the conditions of the offer, that is, to see if Reece actually did buy babysitting services within two weeks of the call.

By querying recipients whose claims have won a first-stage bet, the EVSPS can gather and store data in a claims database and a user database (these databases can be a single database) so that a recipient's claiming history can be analyzed, particularly to find a pattern of cheating.

Accordingly, the invention provides a method for operating an EVSPV including the steps of:
querying a claimant upon a claim winning a first payment bet,
asking the claimant whether the claimant has met the conditions of the EV payment offer,
storing claimant's response or lack of response, in a claims database and/or a user database.

### Section 5B

### System Takes all the Payoff Risk in which EV is Deducted Per Bet from Payer

In this Section B, we assume that the EVSPV takes all the payoff risk in payment bets.

If the EVSPV takes the payoff risk, it will include a system bank account and means discussed above for establishing a payer bank account.

We assume that a payer, Paula, has established a payer bank account.

Then, each time a recipient submits a claim corresponding to Paula's payment offer, the EVSPV will deduct the amount of money specified by Paula's offer from Paula's bank account (for instance, a debit account) and transfer it into an EVSPV account. From that EVSPV account the system will pay payoffs to recipients.

But the process is more complicated than that; it is different from a conventional payment transfer system. The problem is that Paula is offering EV payment only to qualified claimants, but claimants who accept her offer will include qualified claimants and non-qualified claimants.

Assume that Paula offers $1 EV. Now, assume that 2,000 claimants accept her offer.

How much does Paula owe the EVSPV? If she pays $1 per claim it is not fair because she is only supposed to pay for qualified claimants. She does not know and the EVSPV does not know what percentage of claimants is qualified.

Paula and the EVSPV cannot know if a claimant is qualified until the uncertainty is resolved when, and if, a claimant wins his payment bet and submits his payoff claim data for inspection.

Therefore, to compensate Paula for having money deducted from her account for invalid claims (submitted by non-qualified claimants), the EVMSP and EVSPV can include the step of refunding a payoff, provisionally won by a claimant, to Paula when:
1) a claimant does not submit a payoff claim on a winning claim (usually meaning that the claimant does not think that he is a qualified claimant)
2) a claimant does submit a payoff claim, but the corresponding inspection then reveals that the claimant is not qualified—i.e., that payoff claim is invalid.

For example, assume BestSitter is offering $1 EV to referrers. Assume that Ray, the referrer, finds the offer, and selects the offer, thereby claiming the $1 EV. Then, the EVSPV would deduct $1 (definite dollar) from BestSitter's bank account and transfer it into an EVSPV account for paying off winning, valid claims. Assume that Ray's claim wins the payment bet with a payoff of $1,000. Then, assume that Ray does not submit a claim for the payoff. Then, the EVSPV would transfer the $1,000 to the BestSitter account. Likewise, if Ray does submit a claim for the payoff, but the claim is found invalid, then the EVSPV would transfer the $1,000 to the BestSitter account.

Accordingly, the invention provides a method for operating an EVSPV including the steps of:
register a claim by a Reece for a payment corresponding to Paula's EV payment offer,
deduct from Paula's account an amount of definite dollars equal to the EV of Paula's offer, and transfer that definite amount to an EVSPV account,
execute a payment bet to determine whether Reece's claim is a winner,
   if claim loses, set the value of the claim to zero,
   if the claim wins, ask Reece to submit a payoff claim,
      if Reece does not respond to the request, or if Reece responds that he cannot submit a payoff claim, transfer the payoff into Paula's account,
      if Reece submits a payoff claim, pass the claim to an inspector,
         if the inspector enters that the claim is invalid, then transfer the payoff into Paula's account,
         if the inspector enters that the claim is valid, then transfer (or authorize the transfer of) the payoff to Reece.

(To compensate an inspector and encourage users to only submit valid payoff claims, the system can include a process for receiving an inspection fee from a payoff claimant, and/or an inspection deposit, to be forfeited if the claim is invalid.)

The Problem with this Refund Method

The method of refunding payoffs to payers is fair in that, probabilistically speaking, on average, Paula gets back the money, deducted from her account, that pays for non-qualified claimants.

However, this “refunding” process is “lumpy” with infrequent, large payoff refunds that may not suit many payers, especially if the payoffs are too infrequent. For example, if Paula is offering $1 EV, and the payoff is $1,000, Paula may have over $1,000 deducted from her bank account to pay for non-qualified claimants, but she may not even receive a payoff refund. This situation will be unsatisfactory to many payers, especially payers that are very small businesses. Below we give is one solution to this problem. In Parts 3 and 4 we describe two other solutions.

Using a Two-Bet (“Parlay”) Process

One solution is to split one payment bet into two, in which the payoff for the first bet is low enough so that a payer will receive refunds of a first payoff frequently enough to satisfy the payer (Paula). An EVMPV and EVSPV can use a two-bet process, as described in Section A, with two key differences.

One difference is that the system takes the payoff risk in both payment bets. The EV amount is deducted, in definite money, from Paula's account, per claim submission (offer acceptance).

A second difference is that the first bet payoff is refunded to the payer if the claimant (Reece) does not respond to a query after winning the first-stage bet, or if Reece gives a negative response, saying, “I did not meet the conditions of the payment offer.”

If Reece gives a positive response, a second bet is executed. If Reece's claim wins this second stage bet, then the claim is provisionally worth the second payoff.

Paying this payoff is handled the same way that a payoff claim is handled above, in Section B. That is, if an inspection reveals that Reece's claim is invalid, then the second stage payoff is refunded to the payer. If the inspection reveals that Reece's claim is valid, then the second stage payoff is paid to Reece. Accordingly, the invention provides a method for operating an EVSPV including the steps of:
register a claim by Reece corresponding to an EV payment offer by Paula,
transfer from Paula's bank account to an EVSPV account an amount of money (x) equal to the EV offered in by Paula's offer,
execute a first bet in which Reece's payment claim has a first EV=x, and a First Payoff=y,
if Reece's claim loses this first bet, set Reece's claim value=zero, and do not continue making payment bets for the claim,
if Reece's claim wins this first bet, query Reece to see if he says he has met the conditions of the payment offer,
   if Reece does not respond, or if Reece responds, “no,” then transfer (“refund”) the First Payoff, y, to Paula's account,
   if Reece responds, “yes,” then execute a second bet in which Reece's claim has an EV=y, and a payoff=z,
      if Reece's claim loses this second bet, set Reece's claim value=zero, and do not continue making payment bets for the claim,
      if Reece's claim wins this second bet, assign Reece's claim provisional value=z
      ask Reece to submit payoff claim data,
         if Reece does not respond or if he says he cannot submit payoff claim data, then transfer (“refund”) the Second Payoff, z, to Paula's account,
         if Reece does submit payoff claim data, then send the data to an inspector to do an inspection,
            if the inspector finds the claim invalid, register that the claim is invalid and transfer (“refund”) the Second Payoff, z, to Paula's account,
            if the inspector finds the claim valid, pay the Second Payoff, z, to Reece's account (or authorize payment to Reece).

### Section 5C

### Two-Bet Process where Payer and System Take Separate Payoff Risk in which the First Bet Payoff is Deducted from Payer

Section A described a two-bet process in which the payer takes the payoff risk in both bets. Section B described a two-bet process in which the system takes the payoff risk in both bets.

This Section C describes a two-bet process in which the payer takes the payoff risk in the first bet, and the system takes the payoff risk in the second bet.

This particular two-bet method can be useful because many payers cannot risk losing a large payoff, while virtually all payers can risk losing a payoff under a given threshold.

We note that the EVMPV can include steps for enabling a payer to set this threshold, or the threshold can be set by default. This threshold—a static amount or a multiple of a sale amount—can then be used as the payoff for the first bet in a two-bet process.

(As in Parts 1 and 2, we will often call a payer by the name, Paula, and an EV payment recipient/claimant by the name, Reece.)

Accordingly, the invention provides a method for operating an EVSPV including the steps of:
register a claim by Reece corresponding to an EV payment offer by Paula with EV=x,
execute a first bet in which Reece's claim has an EV=x, and a First Payoff=y,
if Reece's claim loses this first bet, set Reece's claim value=zero, and do not continue making payment bets for the claim,
if Reece's claim wins this first bet, then query Reece to see if he says he has met the conditions of the payment offer,
   if Reece does not respond, or if Reece responds, “no,” set claim value=zero,
   if Reece responds, “yes,” transfer y from Paula's account to an EVSPV account,
      execute a second bet in which Reece's claim has EV=y, and Second Payoff=z,
      if Reece's claim loses this second bet, the claim has zero value,
      if Reece's claim wins this second bet, the claim has provisional value=z,
         ask Reece to submit payoff claim data,
         if Reece does not respond or if he says he cannot submit payoff claim data, then transfer (“refund”) the Second Payoff, z, from the EVSPV account to Paula's account,
         if Reece does submit payoff claim data, then send the data to an inspector to do an inspection,
            if the inspector finds the claim invalid, register that the claim is invalid, and transfer (“refund”) the Second Payoff, z, from the EVSPV account to Paula's account,
            if the inspector finds the claim valid, pay Reece the Second Payoff, z, from the EVSPV account.

Importantly, we note that the process above does not have to include steps for informing Reece that his claim has won the first bet; the two-bet aspect can be hidden from him. In this implementation, Reece would not be queried, of course, after the first bet. The First Payoff would be transferred from Paula's account to an EVSPV account, as above. But, in order for Reece to be queried, Reece's claim would have to win both bets. If Reece did not respond to this query, or he if he did respond, and his claim was found invalid, then the EVSPV would transfer the payoff to the Paula's account.

Illustration

As an illustration of the process above, assume that BestSitters sets up an account with the EVSPV and deposits $200.

Assume that BestSitters makes an offer to pay $1 EV to anyone who refers in a customer.

Assume that Ray accepts this offer, that is, submits a claim.

Then the EVSPV registers the claim and executes a first bet with EV=$1 and, let us assume, a First Payoff=$50.

Assume that Ray's claim wins the bet.

Then, the EVSPV deducts $50 from BestSitter's account and transfers it to an EVSPV account for paying payoffs.

Then, the EVSPV informs Ray that his claim has won the first bet and asks Ray whether he has met the conditions of the corresponding payment offer.

If Ray does not respond, or responds negatively, then the EVSPV refunds the $50 to the BestSitter account.

If Ray responds positively, then a second bet is executed, with an EV=$50 and a Second Payoff=$1,000, let us assume.

Then, if Ray wins this bet, the EVSPV asks him to provide proof that he referred in a customer.

If Ray does not respond, or does not provide adequate proof, the EVSPV transfers the $1,000 to the BestSitter account.

If Ray does respond and provides adequate proof of his referral, then the system authorizes the payment of (or simply pays) the $1,000 to Ray.

### Section 5D

### System Takes all the Payoff Risk and Uses a Discount Formula to Adjust for Invalid Claims

One way for the EVSPV to transfer payment from payers to recipients is to take all the risk in the payment bets, but to eliminate the refunding steps described in Section B, and instead use a discount formula that generates a discount factor of some sort.

In Section B, we described a method in which each time a recipient submits a claims corresponding to Paula's EV payment offer, the EVSPV will deduct definite money in the EV amount of the offer from Paula's bank account and transfer it into a EVSPV account. From that EVSPV account the system will pay valid, winning claims.

To repeat from Section B, the process is more complicated than that; it is different from a conventional payment transfer system. The problem is that Paula is offering EV payments only to qualified claimants, but people who accept her offer—submit claims, that is—will include qualified claimants and non-qualified claimants.

To repeat, Paula and the EVSPV cannot know if a claimant is qualified until the uncertainty is resolved by the claimant winning his payment bet and then passing/failing an inspection.

To compensate/adjust for non-qualified claimants, the EVSPV can include a process for applying a discount factor to the EV payment amount that Paula offers to claimants.

Then, each time a user submits a claims for an EV payment under Paula's offer, Paula would not owe EVSPV the full amount of the EV stated in the offer, but a discounted rate. For example, if the EV amount offered to qualified claimants is $1 and the discount factor is 20%, then EVSPV registers that Paula owes 20 definite cents per submitted claim.

The goal in a discount factor is to represent the percentage of claimants who are qualified claimants. To arrive at a fair discount factor, the general idea is to gather statistics on what percentage of claimants are qualified.

These statistics can be gathered from the responses to offers within EVSPV that are similar to Paula's offer. The EVSPV can feed this response data into the discount formula (s).

Other methods, such as survey methods can be used as well to yield discount factor data to be fed into discount formulas as well.

The discount formula (s) will use data on how many winning claims are qualified claims.

EVSPV may include one or more formulas to determine the discount factor to be applied to a payer's offer.

Accordingly, the invention provides a method of operating an EVSPV such that the EVSPV takes the payoff risk in EV payment bets and further includes:
a discount formula process (or processes) for arriving at a discount factor, to be applied to the EV amount of a payment offer.

(Alternatively, in certain implementations, the EVSPV will not include a discount formula, but will include means for enabling a system administrator to enter a discount factor.)

Further, when a user submits a claim for EV payment, the EVSPV will:
apply the appropriate discount factor to the EV payment amount,
deduct the resulting amount from the payer's bank account,
transfer the amount to a EVSPV account that is used to pay winning, qualified claimants.

Further, in the inspection process, when an the inspector approves a claim, the EVSPV will:
register that the claimant is owed the payoff from the EVSPV account that is used to pay winning claimants.

Note that while the amount being deducted from Paula's account is (EV)×(Discount Factor), or EV adjusted in some way by a discount formula, the EV of the payment claim remains the EV that was offered by Paula.

Thus, one weakness of the process above is that Paula and Reece can cheat by acting in cahoots. Because of the discount factor, the amount that Paula has to pay is not the full EV, while the system executes a bet where Reece does receive the full EV. The system makes up the difference. So, if Paula and Reece are cheating, they will receive, on average, (EV)−(EV×Discount Factor).

Using a Two-Bet Process where Payer and System Take Separate Payoff Risk in which the First Bet Payoff, Adjusted by a Discount Factor, is Deducted from the Payer's Account

The EVSPV can enable Paula to take the payoff risk in the first bet, but can apply a discount factor to this First Payoff. Thus, if the claimant wins this first bet, the system can deduct the First Payoff of this first bet, adjusted by the discount factor described above, from Paula's bank account and transfer this discounted First Payoff to the EVSPV account.

The EVSPV can then take the payoff risk in the second bet.

As with the process above, although a discount factor is applied to Paula's payoff obligation, the EV of the claim in this second bet equals the full First Payoff (the payoff of the first bet).

If the claim wins both bets, and if an inspection finds the claim valid, then the EVSPV transfers the second bet payoff to Reece.

### Section 5E

### Two-Bet Processes in which EV Payment Equals a Percentage of a Sale

Context: Payment Offers where the EV Payment Depends on an Uncertain Event, Especially a Purchase Amount (an Amount of Money in a Transaction)

In many kinds of EV payment offers, the amount of EV payment will depend on an uncertain event or series of events, such as the amount of a sale.

In particular, the amount of EV payment can be a percentage of the amount of money involved in an economic transaction, which we will call a sale amount, where sale is a generic term that encompasses any kind of sale, lease, loan, donation—and amount encompasses any amount of money transferred in an economic transaction.

For instance, BestSitters might offer Reece a payment for attention where the EV payment is 1% of how much Reece spends on babysitting services over the next month. In this case, the sale amount, and hence the specific EV payment amount, will not be known until the month has passed.

The EVMPV and EVSPV can include steps for handling payments that are contingent upon uncertain events, in particular, payments that are a percentage of sale amounts.

The steps involved are straightforward if one payment bet is used. In this case, the claimant will provide the sale amount information during the inspection process.

For instance, if BestSitters offers 1% of a sale amount to Reece, then a bet is executed. Let us assume that the probability of Reece's claim winning is 1/1000. Then, if Reece's claims wins, it will be worth 1%×1,000=10,000%=10 times the sale amount.

If Reece's claim wins, the EVSPV will ask Reece if he bought babysitting services over the past month, and if so, how much did he spend?

Let us assume Reece spent $80, then he will be owed $800.

So, to handle percentages, a payoff multiple is used in the EV payment bet.

Two-Bet Processes where Uncertainty is Resolved (Sale Amount Information is Provided) after the First Bet

If a two-bet process is used, then the first bet can use a payoff multiple.

Let us assume that the process of Section C is used in which Paula takes the payoff risk in the first bet and the EVSPV takes the payoff risk in the second bet.

The invention provides a method for operating an EVSPV including the steps described below.

If Reece's claim wins the first bet, the EVSPV can ask Reece if a sale was made, and if so, how much was spent. Reece can supply the answer, and the second bet terms can be based upon this information.

For example, let us assume the payoff multiple in the first bet is 10×, so that the probability of a claim winning is 1/10. Then, if Reece's claim wins this first bet, the claim is provisionally worth 10× the EV payment percentage offered.

Then, the EVSPV asks Reece if a sale was made, and if so, how much was spent. If Reece responds and supplies the sale amount, then this sale amount can be multiplied by the payoff multiple and multiplied by the EV payment percentage to arrive at a First Payoff that can be deducted from Paula's account.

For instance, assume the EV payment percentage offered is 1%. Assume the payoff multiple is 10×. And, assume that Reece says that a $600 sale was made.

Then, (1%)×10×$600=$60. This $60 is transferred from Paula's account to the EVSPV account for paying payoffs. And, this $60 is the EV of the second bet.

Two-Bet Process where the Uncertainty is Resolved (Sale Amount Information is Provided) after the Second Bet

It is also possible NOT to tell Reece that his claim has won the first bet, but simply to deduct some amount of definite money from Paula's account to be transferred into an EVSPV account, that is then used by pay out payoffs.

But, if the sale amount is not known, how much definite money is to be deducted from Paula's account?

One solution is for the EVSPV to check Paula's payment offer and assume the worst-case scenario, that Reece will report that largest sale possible under Paula's offer. The EVSPV, in other words, can deduct the maximum amount from Paula's account.

This method raises the problem of overpayment. To solve this problem, the refunding approach of the processes of Section B and Section C can be used.

When the uncertainty of the sale amount is resolved, the excess payment in definite dollars can be refunded, but refunded multiplied by the payoff multiple.

For example, assume that the payoff multiple of the first bet is 10×, and assume that the payment offer is 1% of a sale amount. Then, Reece is owed 10% of the sale amount.

Assume that the maximum sale amount under Paula's offer is $1,500, then Reece could potentially be owed $150. The EVSPV can deduct this amount from Paula's account.

Then, let us assume that the payoff multiple of the second bet is 10× as well. Then, if Reece's claim wins this bet, the claim is provisionally worth $1,500.

Now, let us assume that Reece submits a payoff claim stating that he spent $90.

Then, Reece would be owed $90 as the second payoff, NOT $1,500.

But, if the uncertainty had been resolved after the first bet, then Paula should only have paid $9, which is 10%×$90. Instead, Paula had $150 deducted from her account. So, she is owed $141. But, it is actually $141×10×−$1410.

Because of the complexity of this approach, it seems that, in practice, the uncertainty will be resolved after a claim wins a first bet, as described above.

### Section 5F

### Using Deposits to Reduce Inspection Costs

Inspecting a Fraction of the Payoff Claims

We expect that in most implementations of the invention, a claimant would have to put up a deposit or pay an inspection fee, both of which can ensure that his claim was valid.

The inspection fee would be paid whether the claim was valid or not. The deposit would be forfeit if the claim were invalid.

A twist on the idea of a deposit, to increase the efficiency of inspection, is to ask claimants to put up a large deposit (to post a bond, so to speak), and only inspect a fraction of the claims, with some pre-set selection method (e.g., random selection of claims).

The un-inspected claims would be presumed valid. The inspected claims, if invalid, would cause the deposit to be confiscated.

Accordingly, the invention provides a method of operating an EVSPV including the steps of:
executing an EV payment bet for a claim,
if the claim is loses, set the value=0,
if the claim wins, ask claimant to submit deposit of money to guarantee that the claim is valid,
   if the claimant does not submit the deposit, set the value of the claim=zero,
   if the claimant submits the deposit, store the deposit in an escrow-type account such that the deposit corresponds to the winning claim,
      subject the claim to a pseudo-random chance of being inspected according to a pre-set selection formula,
      if a winning claim has not been selected for inspection, assume that the claimant meets the conditions of the EV payment offer, pay the winning claimant the payoff, and release the deposit from the escrow account back to the claimant,
      if a winning claim has been selected for inspection, request payoff claim data (inspection data) from the claimant,
         if the claimant does not provide the payoff claim data, set the value of the claim=0, and confiscate the claimant's deposit,
         if the claimant provides payoff claim data, inform an inspector that the claim needs inspecting,
            if the inspector enters a decision that the claim is invalid, set the claim value=0, and confiscate the claimant's deposit,
            if the inspector enters a decision that the claim is valid, set the value of the claim=to the payoff of the payment bet, and authorize payment of the payoff to the claimant, and release the deposit from the escrow account back to the claimant.
               Centering the Invention Around the Use of Deposit (Around the Posting of Bonds)

The EVMPV and EVSPV use expected payments to reduce the number of inspections of claims.

It is possible to reduce inspections solely by using the method of having claimants post a bond to vouch for the honesty of their claims, and then auditing a percentage of those claimants.

We do not feel that this will be the dominant approach in the market because it requires people to put up large deposits upfront, but we note the possibility.

Instead, by reducing the average cost of inspections, the use of deposits may be an important addition to the payment processes of an EVMPV and EVSPV.

Further, and as a separate, useful process, the EVMPV and EVSPV can include steps that enable a claimant to choose whether to be paid:
1) an EV payment or
2) a definite payment contingent upon the claimant putting up a deposit and having the claim subject to inspection, according to a mostly/somewhat random selection.

This approach can work well when an EVSPV enables EV payments that range from small, say, 10 EV cents, to large, say 300 EV dollars. In some cases, claimants will prefer to receive definite payment rather than EV payment.

### Section 5G

### Miscellaneous Sub-Methods for Efficient and User-Friendly Transactions

Periodic EV Payments

In certain cases, an EV payment offer may stipulate that Reece will be paid periodically, such that he must meet the conditions of the payment offer during each, defined period. For example, Paula may offer to pay Reece a 5% EV referral fee for each month that a customer buys from Paula. Each month, then, Paula can check whether the customer has remained a customer. When the customer drops away, then Reece is no longer owed the EV referral fee.

The EVMPV and EVSPV can accommodate periodic payments by treating each period as a separate payment that requires a separate claim to be made. Or the EVMPV and EVSPV can enable a singe claim to trigger a series of payment bets, per period, that continue until a claimant requests that they stop. Or, the EVMPV and EVSPV can assume that the first period payment will determine the total payment. The possibilities are various and will depend upon the implementation and the payment offer.

Allowing Recipients to Assign EV Payments

One problem with the EVMPV and EVSPV is that many claimants do not like EV payment and would prefer definite payment. A way to solve this problem is for a claimant, before the result of his EV bet is revealed, to assign his EV bet payoff to a third party. The third party could pay the claimant a percentage of the EV for this assignment, through a private transaction, thus enabling the claimant to receive definite payment instead of EV payment. The third party would then collect the payoff, if any, upon a successful inspection.

Alternatively, the EVSPV can facilitate and record assignments. Further, the EVSPV could list EV payments to a recipient so that a recipient can assign a set of EV payments to a third party.

Accordingly, the invention can provide a method for operating an EVSPV including the steps of:
enabling a user to designate an assignee for one or more of the EV payments he claims,
enabling a user to state which EV's he is genuinely eligible for—i.e., claims in which he has met the conditions of the EV payment offers,
listing and tallying all the claims for EV payment a user has stated he is genuinely eligible to receive,
designating an assignee for the set of claims for EV payment a user has stated he is genuinely eligible to receive.
   Showing Net EV's

The owners of an EVSPV will usually need to be paid for its operation. As discussed, there are various ways of charging users for the services of the EVSPV. Some of these ways will involve transaction fees. These fees can be reflected in the EV's, odds, and payoffs of payment bets. That is, the EVSPV can show net EV's to claimants/recipients that are different from the EV's advertised by payers in their payment offers.

Meta-Directory for Collecting and Sorting Similar EV Payment Offers

An EVSPV that transacts a particular kind of payment offer, such as a system for targeted discount offers, or referral offers, or payment-for-attention offers, will probably not be a monopoly service. There will be more than one EVSPV doing essentially the same thing.

Given this reality, it will be useful for payers and recipients of payment to collect all similar offers and put them in one sorted list. In other words, it will be useful to create a meta-directory of offers that are posted in EVSPV's.

This kind of meta-directory can be created through a central service that handles queries from payment claimants and then pulls matching offers from various EVSPV's and sorts those offers.

Or, the meta-directory can be created via software on a user's personal machine, such that the software takes a user query for a payment offer and then pulls matching offers from various EVSPV's, and sorts those offers, and presents a sorted list of those offers.

A meta-directory is obviously helpful to payment claimants. But it is also helpful to payers, especially a central service embodiment, because it can help collect global statistics that can be used to deter cheating and make payment offers more efficient.

Comment by James Stein on Reading this Part 5

I was going to make the suggestion of something analogous to your discount factor. However, my suggestion would be to periodically refund to Paula the amount computed by using the discount factor, rather than require Paula to pay EV×discount factor initially.

I think the chances that Reece and Paula will be in cahoots is minimal; the only way that they can make money is to submit large numbers of claims, and I would assume the system can track this—or limit the number (or amount) of claims.

### Part 6

### Methods for Reducing Inspection Costs

Inspecting proof-of-purchase is a step in the payment process of an EVSPQ-RB. Proof can be sent by physical mail or by electronic message, depending on the situation. Proof can be inspected by man and/or machine depending on the situation.

There are costs involved in providing and inspecting that proof.

So, it is useful to reduce the cost of providing and inspecting proof-of-purchase. It is useful to reduce the cost of any inspection required by an EVSPQ and the inspection is basically the same whether a purchase is being inspected or any other conditions. The methods described here apply to inspecting any condition, but we describe them with the application of a purchase condition in mind simply for concreteness and convenience and, because a purchase condition is likely to be important in the marketplace.

As described in U.S. utility application Ser. No. 10/042,975, one method of reducing these costs is to trust the potential recipient of a payoff to tell the truth about whether a purchase has taken place, without demanding that the recipient send proof. In this method, the recipient's assertion of having proof would be audited with some probability of the audit taking place. Auditing reduces the number of inspections dramatically, depending on the probability of an audit (inspection).

If an audit method is used, then the recipient would be penalized if he has lied about being able to prove that he made a purchase. Penalties can include a financial penalty or the loss of system privileges. In addition, as a condition of collecting a payoff, a provisionally winning recipient can be required to put up a deposit in advance, to be forfeit if the recipient is audited and fails the audit.

Reducing the Cost of Providing and Inspecting Proof-of-Purchase by the Use of Partial Proof Information that is Statistically Analyzed

Another method of reducing the cost of providing proof is to require a winning recipient to provide certain partial information from the purchase (transaction) receipt. For example, a genuine receipt might have on it:
Office Supply Vendor
Transaction number 4532-P6JK
Purchase: 8 inkjet printers . . .

The winning recipient might be asked to provide, for example, just the transaction number (receipt number). Such a number is easy to send in an electronic message.

This partial proof information could then be analyzed by machine algorithm incorporated into the inspection process.

The reason this approach can work is that it can be difficult for most recipients to fake receipt information. In other words, a machine algorithm can potentially spot fakes. Where a fake is detected, or where a threshold is reached by the fake detection algorithm, the inspection process can alert the recipient who has submitted the suspect information to provide more extensive proof of purchase. A user who does not then provide the additional information could be disqualified from collecting the EV payment payoff, and could be further penalized.

Reducing the Cost of Providing and Inspecting Proof-of-Purchase by the Use of a Bet with the Provider of Proof

If an auditing method is used, or a partial proof method is used, or both in combination, then another sub-method can be added to discourage and detect cheats, as follows.

The winning recipient, who is provisionally owed a payoff, can be required to put up a deposit, in effect to guarantee that his proof-of-purchase will “pass” inspection.

As noted, rather than perform the inspection, the system can give the recipient the benefit of the doubt, which auditing with some probability, to encourage compliance.

As an additional process, the system can, with some probability, make a bet with the recipient, betting that the recipient does not have adequate proof-of-purchase—i.e., betting that the recipient is lying about having proof-of-purchase. In this process, the system would put up an amount of money, and the recipient would have to put up an amount of money, in addition to the deposit. Odds and stakes in such a bet would depend upon the implementation.

If the recipient is willing to risk an additional amount of money beyond the deposit, he may have valid proof-of-purchase. If the recipient refuses to bet, that usually means he doesn't have valid proof.

Now, if he refuses to put up the deposit in the first place because he is afraid of having to make an additional bet, then he probably does not have valid proof. So, the fear of having his deposit confiscated via the threat of a bet may deter false assertions of having proof-of-purchase, that is. In effect, the threat of the bet, just like the threat of the confiscation of a deposit (a type of bet itself), encourages honesty. In other words, the threat of a bet may be a reasonable enough of a lie-detector/deterrer to make the additional betting process worthwhile. It is a type of inspection.

I claim:

1. A method for improving the operation of an expected value system for paying and qualifying audiences (EVSPQ), an online database system for paying EV payments to users for their attention, provided they meet specified conditions, in which advertisers post EV payment offers that recipient users accept, in which, in an EVSPQ for paying “realbuyers” (EVSPQ-RB) a qualifying condition of payment is that a user makes a purchase after being exposed to a specified message,
the inventive method is a module to be added to an EVSPQ-RB to limit EV payments paid for attention by a prospect for a specified purchase (economic transaction),
the method comprises the following steps executed by the EVSPQ-RB:
the system storing all acceptances of EV payment by a recipient,
after the recipient wins an EV payment bet and also submits a payoff claim stating that a specified, required purchase was made, the system finds all acceptances that match the purchase,
the system enables a system operator to search the recipient's acceptance history to find additional matches and to eliminate false matches, yielding a full match set,
the system applies a division formula to all the EV payments in the full match set, such that the payoff of the bet that the recipient has won is discounted by an amount determined by this division formula.
